(19) United States
(12) Patent Application Publication
(10) Pub. No.: US 2021/0026509 A1
(43) Pub. Date: Jan. 28, 2021

(54) COMMUNICATION TERMINAL, COMMUNICATION SYSTEM, IMAGE SHARING METHOD, AND NON-TRANSITORY RECORDING MEDIUM

(71) Applicants: Takeshi HOMMA, Kanagawa (JP); Shigeru NAKAMURA, Kanagawa (JP); Yuichi KAWASAKI, Kanagawa (JP); Hiroshi HINOHARA, Kanagawa (JP); Atsushi MIYAMOTO, Kanagawa (JP); Kenichiro MORITA, Tokyo (JP); Masashi OGASAWARA, Tokyo (JP)

(72) Inventors: Takeshi HOMMA, Kanagawa (JP); Shigeru NAKAMURA, Kanagawa (JP); Yuichi KAWASAKI, Kanagawa (JP); Hiroshi HINOHARA, Kanagawa (JP); Atsushi MIYAMOTO, Kanagawa (JP); Kenichiro MORITA, Tokyo (JP); Masashi OGASAWARA, Tokyo (JP)

(73) Assignee: Ricoh Company, Ltd.

(21) Appl. No.: 16/889,817

(22) Filed: Jun. 2, 2020

(30) Foreign Application Priority Data
Jul. 25, 2019 (JP) 2019-137045

(51) Int. Cl. G06F 3/0484

(52) U.S. Cl. CPC G06F 3/0484

(57) ABSTRACT

A communication terminal includes circuitry that receives, from a communication management apparatus, an operation restriction notification for restricting an operation on a display image to be displayed on a display. The communication management apparatus controls communication between the communication terminal and another communication terminal that shares data of the display image with the communication terminal. In response to receipt of the operation during an operation restriction period in which the operation on the display image is restricted, the circuity controls the display to display a plurality of options as to whether to reflect the received operation in the display image.

### CROSS-REFERENCE TO RELATED APPLICATION

This patent application is based on and claims priority pursuant to 35 U.S.C. § 119(a) to Japanese Patent Application No. 2019-137045 filed on Jul. 25, 2019 in the Japan Patent Office, the entire disclosure of which is hereby incorporated by reference herein.

### BACKGROUND

### Technical Field

The present invention relates to a communication terminal, a communication system, an image sharing method, and a non-transitory recording medium.

### Description of the Related Art

There is a widely used communication system that enables communication between remote sites via a communication network such as the Internet. An example of such a communication system is a conference system that enables a remote conference. In a typical conference system, image data being held or displayed by a communication terminal used by one of two parties participating in the remote conference is transmitted, via the communication network, to a communication terminal used by the other party, thereby enabling the two parties to share the image data. With this system, the conference between the remote sites is held in a setting close to that of a conference held in the same physical space.

Further, in conferences or meetings held in organizations such as companies, educational institutions, and governmental institutions, a communication terminal such as an electronic whiteboard has been used which displays an image on a display so that a user renders a stroke image of a letter, character, number, or figure, for example, on the image. The stroke image is rendered based on stroke data including coordinate data. The communication terminal generates the stroke data by electronically converting content rendered on the display by a user by moving an electronic pen or a finger over the display while keeping the electronic pen or the finger in contact with the display. When the stroke image is rendered on one communication terminal, stroke data for reproducing the stroke image is transmitted from the one communication terminal to the other communication terminal via the communication network. Thereby, the other communication terminal displays the same stroke image.

Further, there is a method that provides an individual user with the right to access a display screen displayed on a communication terminal such as an electronic whiteboard.

According to the method, however, if one of the above-described communication terminals sharing a display image receives an operation (e.g., an operation of moving the stroke image) from a user when the operation (e.g., an access operation) of the communication terminal is restricted, for example, the user is typically requested to perform the same operation after the operation restriction is cancelled. That is, the user operation received during an operation restriction period is not reflected in the display image.

### SUMMARY

In one embodiment of this invention, there is provided an improved communication terminal that includes, for example, circuitry that receives, from a communication management apparatus, an operation restriction notification for restricting an operation on a display image to be displayed on a display. The communication management apparatus controls communication between the communication terminal and another communication terminal that shares data of the display image with the communication terminal. In response to receipt of the operation during an operation restriction period in which the operation on the display image is restricted, the circuity controls the display to display a plurality of options as to whether to reflect the received operation in the display image.

In one embodiment of this invention, there is provided an improved communication system that includes, for example, a plurality of communication terminals and a communication management apparatus. The plurality of communication terminals include at least a first communication terminal and a second communication terminal each configured as the above-described communication terminal. The communication management apparatus includes circuitry that receives, from the first communication terminal, an operation request to reflect an operation received by the first communication terminal in a display image to be displayed on a display. In response to receipt of the operation request from the first communication terminal, the circuitry transmits to the second communication terminal an operation restriction notification for restricting an operation on the display image.

In one embodiment of this invention, there is provided an improved image sharing method executed by a communication terminal. The image sharing method includes, for example, receiving an operation restriction notification for restricting an operation on a display image to be displayed on a display from a communication management apparatus that controls communication between the communication terminal and another communication terminal that shares data of the display image with the communication terminal, and in response to receipt of the operation during an operation restriction period in which the operation on the display image is restricted, controlling the display to display a plurality of options as to whether to reflect the received operation in the display image.

In one embodiment of this invention, there is provided a non-transitory recording medium storing a plurality of instructions which, when executed by one or more processors, cause the processors to perform the above-described image sharing method.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an example of communication routes in a communication system of an embodiment of the present invention;

FIG. 2 is a diagram illustrating use of an electronic whiteboard included in the communication system of the embodiment;

FIG. 3 is a diagram illustrating an example of the hardware configuration of the electronic whiteboard of the embodiment;

FIG. 4 is a diagram illustrating an example of the hardware configuration of each of a communication management apparatus, a relay apparatus, and an image storing apparatus included in the communication system of the embodiment;

FIG. 5 is a diagram illustrating an example of the system configuration of the communication system of the embodiment;

FIGS. 6A and 6B are diagrams illustrating an example of the functional configuration of the communication system of the embodiment;

FIG. 7 is a conceptual diagram illustrating an example of a rendering condition management table of the embodiment;

FIG. 8 is a diagram schematically illustrating an example of rendering screen information of the embodiment;

FIG. 9A is a conceptual diagram illustrating an example of an authentication management table of the embodiment;

FIG. 9B is a conceptual diagram illustrating an example of a terminal management table of the embodiment;

FIG. 10A is a conceptual diagram illustrating an example of a destination list management table of the embodiment;

FIG. 10B is a conceptual diagram illustrating an example of a session management table of the embodiment;

FIG. 10C is a conceptual diagram illustrating an example of a relay apparatus management table of the embodiment;

FIG. 11A is a conceptual diagram illustrating an example of a rendering screen information management table of the embodiment;

FIG. 11B is a conceptual diagram illustrating an example of an operation authority management table of the embodiment;

FIG. 12 is a sequence diagram illustrating an example of a preparatory process to start remote communication between electronic whiteboards of the embodiment;

FIG. 13 is a diagram illustrating an example of a destination list screen displayed on the electronic whiteboards of the embodiment;

FIG. 14 is a sequence diagram illustrating an example of a remote communication start process of the embodiment;

FIG. 15 is a sequence diagram illustrating an example of a stroke data sharing process of the embodiment;

FIG. 16 is a sequence diagram illustrating a part of an example of a process of performing rendering on the electronic whiteboard in accordance with an operation restriction in the communication system of the embodiment;

FIGS. 17A, 17B, 17C, and 17D are diagrams illustrating examples of a rendering screen displayed on the electronic whiteboard of the embodiment;

FIG. 18 is a flowchart illustrating an example of an operation authority determination process performed by the communication management apparatus of the embodiment;

FIG. 19 is a sequence diagram illustrating the remaining part of the example of the process of performing rendering on the electronic whiteboard in accordance with the operation restriction in the communication system of the embodiment;

FIG. 20 is a flowchart illustrating an example of a process of selecting rendering content in the electronic whiteboard of the embodiment;

FIG. 21 is a diagram schematically illustrating rendering screen information generated in the electronic whiteboard of the embodiment in response to receipt of a lock cancellation notification;

FIG. 22 is a diagram illustrating an example of a rendering content selection image displayed on the electronic whiteboard of the embodiment;

FIGS. 23A, 23B, 23C, and 23D are diagrams illustrating examples of the rendering screen displayed on the electronic whiteboard of the embodiment after cancellation of the operation restriction;

FIGS. 24A and 24B are diagrams illustrating an example of the functional configuration of a communication system of a modified example of the embodiment;

FIGS. 25 and 26 are sequence diagrams illustrating an example of a process of performing rendering on the electronic whiteboard in accordance with the operation restriction in the communication system of the modified example of the embodiment;

FIG. 27 is a flowchart illustrating an example of a process of generating the rendering screen in a communication management apparatus in the communication system of the modified example of the embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. In the drawings illustrating embodiments of the present invention, members or components having the same function or shape will be denoted with the same reference numerals to avoid redundant description.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

An embodiment of the present invention will be described below with the drawings.

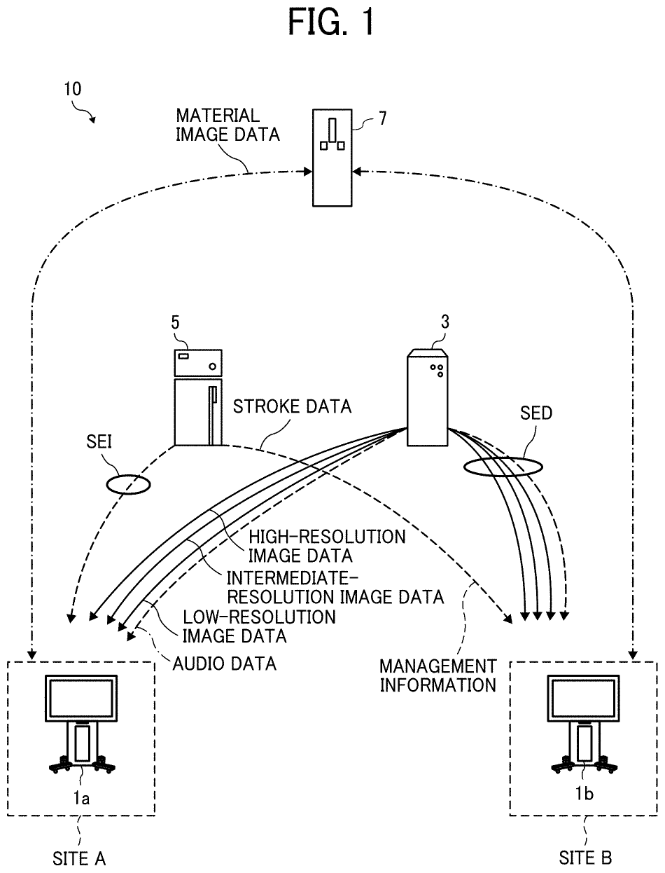

With reference to FIG. 1, a description will be given of an overview of a communication system 10 of the embodiment for enabling a video conference between a plurality of electronic whiteboards 1a and 1b while allowing users to perform rendering on the electronic whiteboards 1a and 1b.

FIG. 1 is a schematic diagram illustrating an example of communication routes in the communication system 10 of the embodiment. The video conference may also be referred to as the television (TV) conference or a remote conference, for example. The video conference, the TV conference, or the remote conference is an example of a session for sharing image data and stroke data between a plurality of terminals. For example, the session for sharing the image data and the stroke data may be a session other than the conference, such as distance learning, remote diagnosis, meeting, or simple conversation. Further, the session for sharing the image data and the stroke data may be used for unidirectional provision of information.

The communication system 10 includes the plurality of electronic whiteboards 1a and 1b, at least one relay apparatus 3, a communication management apparatus 5, and an image storing apparatus 7. The electronic whiteboards 1a and 1b communicate therebetween image data and audio data for communication and content data such as image data and stroke data for sharing. The stroke data is data for reproducing (i.e., duplicating) a stroke image, and includes coordinate data, line width data, line color data, vector data, and data representing the writing pressure applied to render a stroke, for example. The stroke data is transmitted and received between the electronic whiteboards 1a and 1b as a serialized character string. Each of the electronic whiteboards 1a and 1b transmits and receives therebetween the image data and the audio data for communication to reproduce a site image and sound of the site at which the other electronic whiteboard 1a or 1b is located, thereby performing remote video communication.

With the electronic whiteboards 1a and 1b transmitting and receiving therebetween the image data of a material image for sharing, the users of the communication system 10 (i.e., the participants of the video conference) share the same material image. The material image is an image displayed on respective displays of the electronic whiteboards 1a and 1b. The material image includes the image of a material for use in the video conference and a background image displayed on the displays, for example. The image data of the material image is transmitted and received in a file format such as the joint photographic experts group (JPEG) format. The electronic whiteboards 1a and 1b further transmit and receive therebetween the stroke data of the stroke image for sharing, thereby enabling the users of the communication system 10 (i.e., the participants of the video conference) to share the same stroke image. The stroke image is the image of a line, for example, which is rendered based on a handwritten stroke made by the user with an electronic pen, for example. The stroke image is displayed based on the stroke data, which represents points identifying coordinates on the display.

The electronic whiteboards included in the communication system 10 are not limited to the two electronic whiteboards 1a and 1b, and thus the communication system 10 may include three or more electronic whiteboards. In the following description, the electronic whiteboards 1a and 1b may be collectively referred to as the electronic whiteboards 1. Each of the electronic whiteboards 1 is an example of a communication terminal having functions such as a communication function, a rendering function, and a display function. For example, the communication terminal may be a personal computer (PC), a smartphone, a tablet terminal, a smartwatch, a car navigation terminal, a gaming device, or a telepresence robot installed with an application program compatible with the communication system 10. Further, the communication terminal may be medical equipment, in which case the material image may be the image of a patient.

FIG. 1 illustrates the electronic whiteboards 1a and 1b each as an example of an electronic whiteboard with a video conference function. The site image, which is based on site image data, may be a video or still image.

An electronic whiteboard as a source of a video conference start request will be referred to as the starting terminal, and an electronic whiteboard as a destination to which the video conference start request is transmitted or relayed will be referred to as the destination terminal. In FIG. 1, the electronic whiteboard 1a at a site A and the electronic whiteboard 1b at a site B are illustrated as the starting terminal and the destination terminal, respectively. When the video conference start request is transmitted from the electronic whiteboard 1b, however, the electronic whiteboard 1b serves as the starting terminal, and the electronic whiteboard 1a serves as the destination terminal. The electronic whiteboards 1a and 1b may be used not only in communication between a plurality of offices and communication between different rooms in the same office but also in communication in the same room, communication between an indoor space and an outdoor space, and communication between an outdoor space and another outdoor space.

The relay apparatus 3, which is implemented by a computer, performs a process of relaying the content data for communication between the electronic whiteboards 1a and 1b.

The communication management apparatus 5, which is implemented by a computer, performs login authentication of the electronic whiteboards 1a and 1b and centrally manages the respective communication states of the electronic whiteboards 1a and 1b, the communication state of the relay apparatus 3, and a destination list. The communication management apparatus 5 further relays the stroke data for sharing between the electronic whiteboards 1a and 1b.

The image storing apparatus 7, which is implemented by a computer, stores the image data of the material image for sharing uploaded by the electronic whiteboard 1a and downloads the image data to the electronic whiteboard 1b, and vice versa. That is, the image storing apparatus 7 stores the image data uploaded by the electronic whiteboard 1b and downloads the image data to the electronic whiteboard 1a.

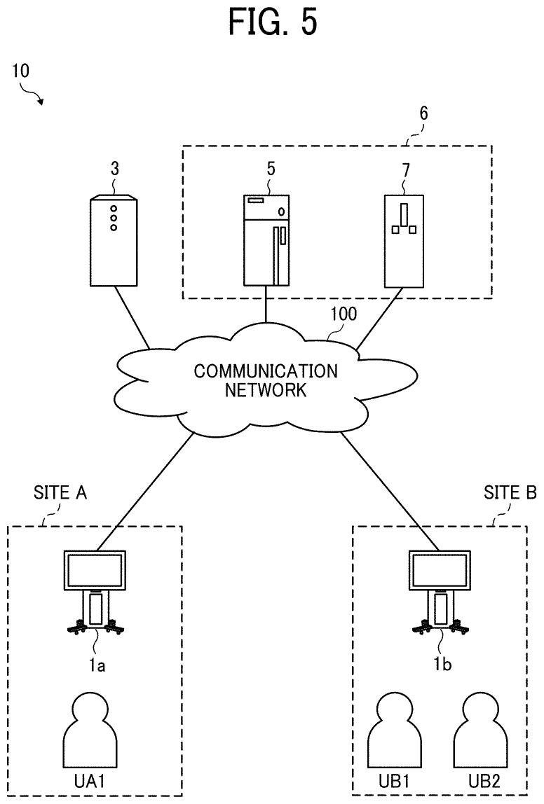

Each of the relay apparatus 3, the communication management apparatus 5, and the image storing apparatus 7 may be implemented by a single computer, or may be implemented by a plurality of computers to which units (i.e., functions or devices) of the apparatus are divided and allocated as desired. The communication management apparatus 5 and the image storing apparatus 7 form a server system 6 (see FIG. 5) that manages the data shared by the electronic whiteboards 1a and 1b. The server system 6 may be implemented by a single computer including the units (i.e., functions or devices) of the communication management apparatus 5 and the image storing apparatus 7. Further, instead of the communication management apparatus 5, the image storing apparatus 7 may relay the stroke data for sharing between the electronic whiteboards 1a and 1b.

In the communication system 10, a management information session SEI is established between the electronic whiteboards 1a and 1b to transmit and receive therebetween various management information via the communication management apparatus 5. Further, four sessions are established between the electronic whiteboards 1a and 1b to transmit and receive therebetween four types of data: high-resolution site image data, intermediate-resolution site image data, low-resolution site image data, and audio data. In FIG. 1, the four sessions are collectively illustrated as an image and audio data session SED. The image and audio data session SED does not necessarily include four sessions, and may include three or less sessions or five or more sessions. Further, the communication session may be established directly between the starting terminal and the destination terminal without via the relay apparatus 3. Further, in the communication system 10, the communication management apparatus 5 may have the function of the relay apparatus 3 such that the image and audio data session SED is established between the electronic whiteboards 1a and 1b via the communication management apparatus 5. Further, in the communication system 10, the stroke data is transmitted and received between the electronic whiteboards 1a and 1b via the management information session SEI.

The image resolution of the site image data in the present embodiment will be described.

The low-resolution site image data, which forms a base image, includes 160 pixels in the horizontal direction by 120 pixels in the vertical direction, for example. The intermediate-resolution site image data includes 320 pixels in the horizontal direction by 240 pixels in the vertical direction, for example. The high-resolution site image data includes 640 pixels in the horizontal direction by 480 pixels in the vertical direction, for example. When the site image data routes through a narrow band path, low-quality image data including the low-resolution site image data for forming the base image is relayed. When the site image data routes through a relatively wide band path, intermediate-quality image data including the low-resolution site image data for forming the base image and the intermediate-resolution site image data is relayed. When the site image data routes through a substantially wide band path, high-quality image data including the low-resolution site image data for forming the base image, the intermediate-resolution site image data, and the high-resolution site image data is relayed. The audio data has a smaller data volume than that of the site image data, and thus is relayed even through a narrow band path.

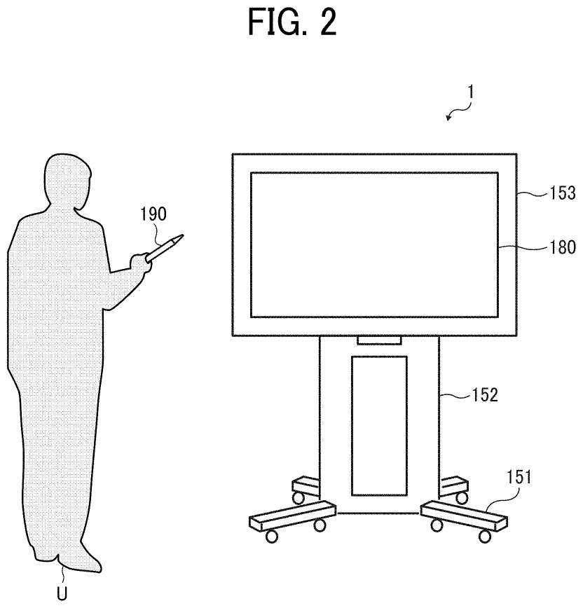

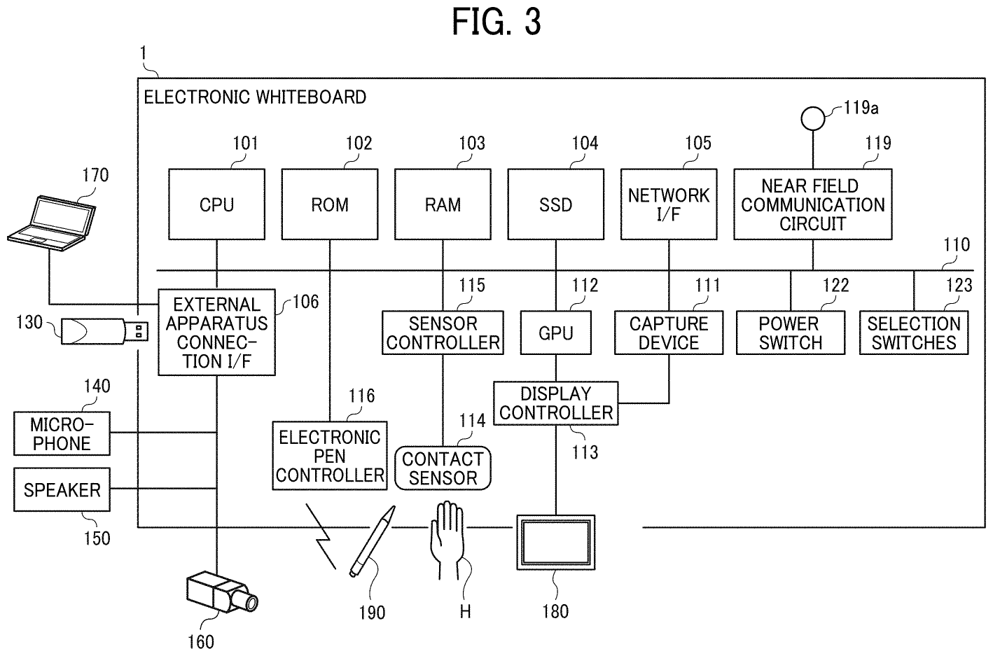

FIG. 2 is a diagram illustrating use of the electronic whiteboard 1 of the embodiment. As illustrated in FIG. 2, the electronic whiteboard 1 includes a foot 151, a support post 152, a main unit 153, and a display 180. A lower side of the foot 151 is equipped with a plurality of casters, and an upper side of the foot 151 is equipped with the support post 152. The main unit 153 is disposed on an upper side of the support post 152, and has a front surface equipped with the display 180. The main unit 153 includes therein a later-described central processing unit (CPU) 101 (see FIG. 3). A user U inputs (i.e., renders) the stroke image of a letter or character, for example, on the display 180 with an electronic pen 190.

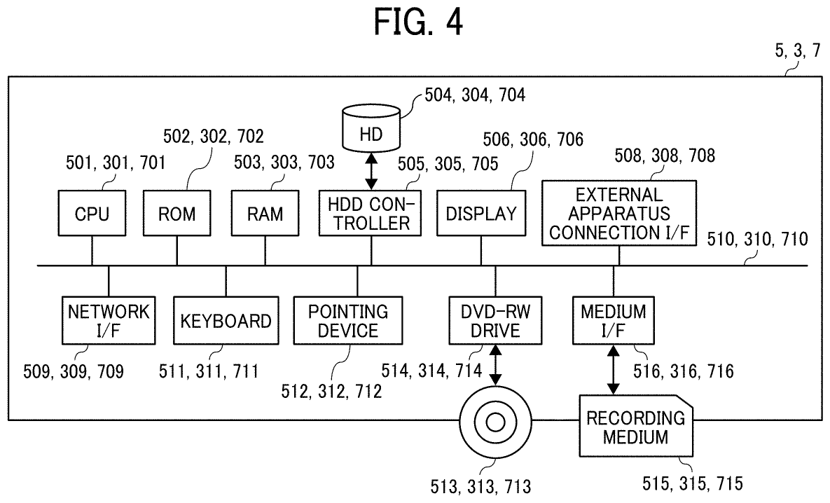

With reference to FIGS. 3 and 4, a description will be given of respective hardware configurations of apparatuses and terminals forming the communication system 10. A component may be added to or removed from each of the hardware configurations in FIGS. 3 and 4 as necessary.

FIG. 3 is a diagram illustrating an example of the hardware configuration of the electronic whiteboard 1 of the embodiment. As illustrated in FIG. 3, the electronic whiteboard 1 includes the CPU 101, a read only memory (ROM) 102, a random access memory (RAM) 103, a solid state drive (SSD) 104, a network interface (I/F) 105, and an external apparatus connection I/F 106.

The CPU 101 controls an overall operation of the electronic whiteboard 1. The ROM 102 is a nonvolatile memory that stores a program for the CPU 101 and a program used to drive the CPU 101 such as an initial program loader (IPL). The RAM 103 is a volatile memory used as a work area for the CPU 101. The SSD 104 is a high-capacity memory that stores various data of a program for the electronic whiteboard 1, for example. The network I/F 105 is a communication interface for connecting the electronic whiteboard 1 to a communication network 100 (see FIG. 5) to perform communication. The external apparatus connection I/F 106 is an interface for connecting the electronic whiteboard 1 to various external apparatuses. The external apparatuses in this case include a universal serial bus (USB) memory 130 and other external apparatuses such as a microphone 140, a speaker 150, and a camera 160, for example.

The electronic whiteboard 1 further includes a capture device 111, a graphics processing unit (GPU) 112, a display controller 113, a contact sensor 114, a sensor controller 115, an electronic pen controller 116, a near field communication circuit 119, an antenna 119a for the near field communication circuit 119, a power switch 122, and selection switches 123.

The capture device 111 displays image data (i.e., image information) on a display of an external PC 170, for example, as a still or video image. The GPU 112 is a semiconductor chip processor dedicated to graphics processing. The display controller 113 controls and manages screen display to output an image from the GPU 112 to the display 180, for example. The contact sensor 114 detects the contact of the electronic pen 190 or a hand H of a user, for example, on the display 180. The sensor controller 115 controls the processing of the contact sensor 114. The contact sensor 114 performs input and detection of coordinates in accordance with an infrared blocking method. In this method of inputting and detecting coordinates, two light receiving devices disposed on opposite end portions of an upper area of the display 180 radiate a plurality of infrared rays parallel to the display 180, and receive rays of light reflected by a reflecting member disposed around the display 180 and returning on optical paths of the rays radiated by the two light receiving devices. The contact sensor 114 outputs, to the sensor controller 115, identifiers (IDs) of the infrared rays radiated by the two light receiving devices and blocked by an object. Then, the sensor controller 115 identifies the position of the coordinates corresponding to the position of contact of the object on the display 180. The electronic pen controller 116 communicates with the electronic pen 190 to determine contact or non-contact of the head or end of the electronic pen 190 on the display 180. The near field communication circuit 119 is a communication circuit conforming to a standard such as the near field communication (NFC) or Bluetooth (registered trademark) standard. The power switch 122 is a switch for switching on or off power supply to the electronic whiteboard 1. The selection switches 123 are switches for adjusting parameters such as the brightness and the color tone of the image displayed on the display 180.

The electronic whiteboard 1 further includes a bus line 110, which includes address buses and data buses to electrically connect the CPU 101 and the other components in FIG. 3 to each other.

The contact sensor 114 is not limited to the infrared blocking method, and may employ a different type of detecting device, such as a capacitance touch panel that identifies the contact position by detecting a change in capacitance, a resistive touch panel that identifies the contact position by detecting a change in voltage of two resistance films facing each other, or an electromagnetic induction touch panel that identifies the contact position by detecting electromagnetic induction caused by contact of an object on a display. Further, the electronic pen controller 116 may determine contact or non-contact of a part of the electronic pen 190 held by the user or another part of the electronic pen 190, as well as the head or end of the electronic pen 190.

FIG. 4 is a diagram illustrating an example of the hardware configuration of each of the communication management apparatus 5, the relay apparatus 3, and the image storing apparatus 7 of the embodiment. A computer as an example of the communication management apparatus 5 includes a CPU 501, a ROM 502, a RAM 503, a hard disk (HD) 504, a hard disk drive (HDD) controller 505, a display 506, an external apparatus connection I/F 508, a network I/F 509, a keyboard 511, a pointing device 512, a digital versatile disc rewritable (DVD-RW) drive 514, a medium I/F 516, and a bus line 510.

The CPU 501 controls an overall operation of the communication management apparatus 5. The ROM 502 is a nonvolatile memory that stores a program used to drive the CPU 501 such as the IPL. The RAM 503 is a volatile memory used as a work area for the CPU 501. The HD 504 is a high-capacity memory that stores various data of a communication management program, for example. The HDD controller 505 controls writing and reading of various data to and from the HD 504 under the control of the CPU 501. The display 506 displays various information such as a cursor, menus, windows, text, and images. The external apparatus connection I/F 508 is an interface for connecting the communication management apparatus 5 to various external apparatuses. The network I/F 509 is an interface for data communication via the communication network 100 such as the Internet. The keyboard 511 is an input device including a plurality of keys for inputting text, numerical values, and various instructions, for example. The pointing device 512 is an input device used to select and execute various instructions, select a processing target, and move the cursor, for example. The DVD-RW drive 514 controls writing (i.e., storage) and reading of data to and from a DVD-RW 513. The DVD-RW 513 may be replaced by a DVD-recordable (DVD-R), for example. Further, the DVD-RW drive 514 may be replaced by a Blu-ray (registered trademark) drive that controls writing (i.e., storage) and reading of data to and from a Blu-ray disc rewritable (BD-RE) or a compact disc-rewritable (CD-RW) drive that controls writing (i.e., storage) and reading of data to and from a CD-RW. The medium I/F 516 controls writing (i.e., storage) and reading of data to and from a recording medium 515 such as a flash memory. The bus line 510 includes address buses and data buses to electrically connect the CPU 501 and the other components in FIG. 4 to each other.

The relay apparatus 3 is implemented by a typical computer. As illustrated in FIG. 4, the relay apparatus 3 includes a CPU 301, a ROM 302, a RAM 303, an HD 304, an HDD controller 305, a display 306, an external apparatus connection I/F 308, a network I/F 309, a keyboard 311, a pointing device 312, a DVD-RW drive 314, a medium I/F 316, and a bus line 310. These components are similar in configuration to the CPU 501, the ROM 502, the RAM 503, the HD 504, the HDD controller 505, the display 506, the external apparatus connection I/F 508, the network I/F 509, the keyboard 511, the pointing device 512, the DVD-RW drive 514, the medium I/F 516, and the bus line 510 of the communication management apparatus 5, and thus description thereof will be omitted. In the relay apparatus 3, however, the HD 304 stores a relay program.

The image storing apparatus 7 is implemented by a typical computer. As illustrated in FIG. 4, the image storing apparatus 7 includes a CPU 701, a ROM 702, a RAM 703, an HD 704, an HDD controller 705, a display 706, an external apparatus connection I/F 708, a network I/F 709, a keyboard 711, a pointing device 712, a DVD-RW drive 714, a medium I/F 716, and a bus line 710. These components are similar in configuration to the CPU 501, the ROM 502, the RAM 503, the HD 504, the HDD controller 505, the display 506, the external apparatus connection I/F 508, the network I/F 509, the keyboard 511, the pointing device 512, the DVD-RW drive 514, the medium I/F 516, and the bus line 510 of the communication management apparatus 5, and thus description thereof will be omitted. In the image storing apparatus 7, however, the HD 704 stores an image storage program.

Each of the above-described programs may be distributed as recorded on a computer readable recording medium in an installable or executable file format. Examples of the recording medium include a compact disc recordable (CD-R), a DVD, a Blu-ray disc, and a secure digital (SD) card. The recording medium may be shipped to the market as a program product. For example, the electronic whiteboard 1 implements an image sharing method of the present invention by executing a program of the present invention.

A general arrangement of the communication system 10 will be described with FIG. 5.

FIG. 5 is a diagram illustrating an example of the system configuration of the communication system 10 of the embodiment. In FIG. 5, the electronic whiteboard 1a and the electronic whiteboard 1b are located at the site A and the site B, respectively. The site A may be a Tokyo branch in Japan, and the site B may be a Beijing branch in China, for example. It is assumed here that the electronic whiteboard 1a is used by a user UA1 at the site A, and that the electronic whiteboard 1b is used by users UB1 and UB2 at the site B.

The electronic whiteboards 1a and 1b, the relay apparatus 3, the communication management apparatus 5, and the image storing apparatus 7 transmit and receive data to and from each other via the communication network 100 such as the Internet or a local area network (LAN), for example. The communication in the communication network 100 is not limited to wired communication, and wireless communication conforming to a standard such as the wireless fidelity (Wi-Fi, registered trademark) standard may take place in some part of the communication network 100.

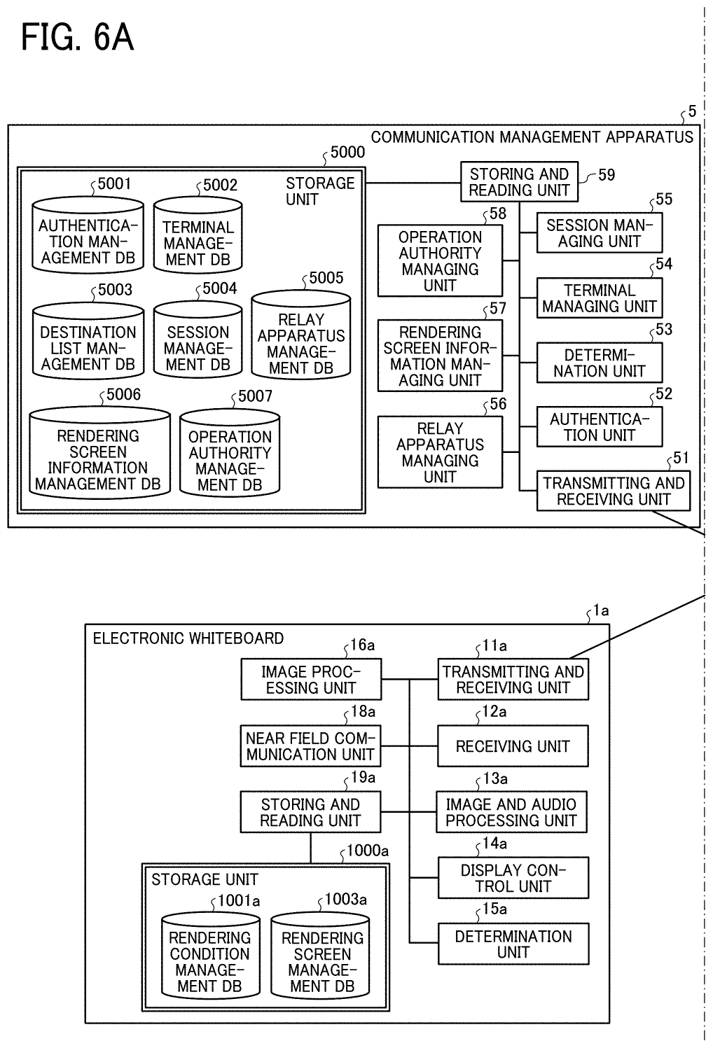

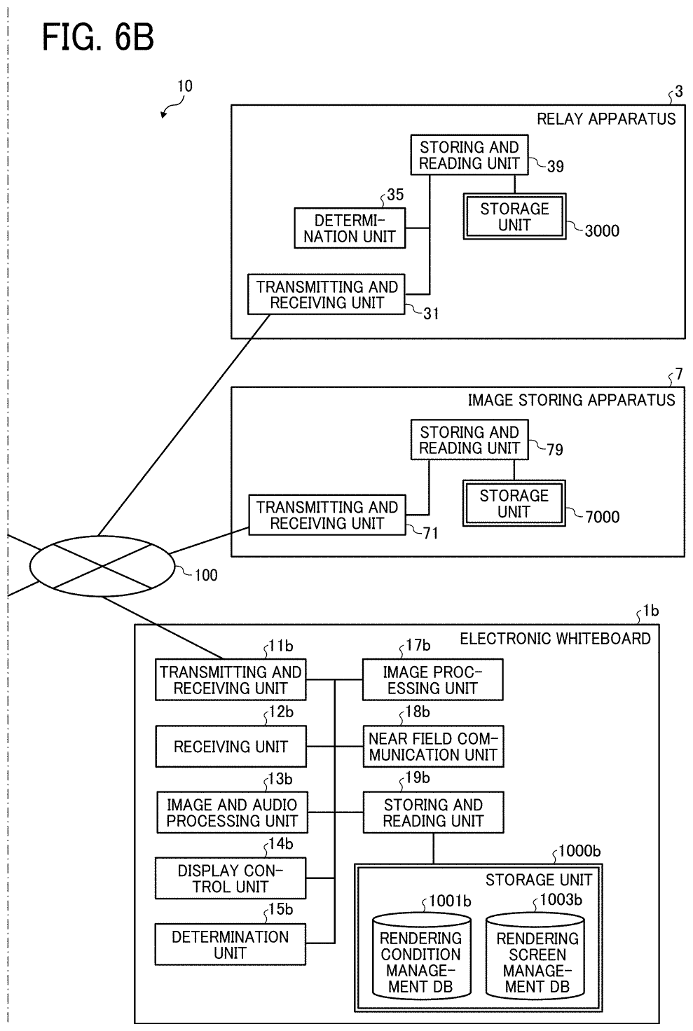

A functional configuration of the communication system 10 of the embodiment will be described with FIGS. 6A and 6B to FIGS. 11A and 11B. FIGS. 6A and 6B are diagrams illustrating an example of the functional configuration of the communication system 10 of the embodiment. FIGS. 6A and 6B illustrate parts of the terminals, apparatuses, and server system in FIG. 5 related to processes and operations described later.

A functional configuration of each of the electronic whiteboards 1a and 1b will be described with FIGS. 6A and 6B. Since the electronic whiteboards 1a and 1b have similar functions, the following description will be given of the functions of the electronic whiteboard 1 with omission of the suffix a or b after each reference numeral.

The electronic whiteboard 1 includes a transmitting and receiving unit 11, a receiving unit 12, an image and audio processing unit 13, a display control unit 14, a determination unit 15, an image processing unit 16, a near field communication unit 18, and a storing and reading unit 19. Each of these units is a function or functional unit implemented when at least one of the components illustrated in FIG. 3 operates in response to a command from the CPU 101 in accordance with the program deployed on the RAM 103 from the SSD 104.

The electronic whiteboard 1 further includes a storage unit 1000 implemented by the RAM 103, the SSD 104, or the USB memory 130 illustrated in FIG. 3.

The transmitting and receiving unit 11 is a function implemented by a command from the CPU 101 and the network I/F 105 in FIG. 3 to transmit and receive various data and information to and from another terminal, apparatus, or system via the communication network 100. The transmitting and receiving unit 11 also functions as a starting unit, for example, to perform a process of starting communication with another electronic whiteboard 1. The transmitting and receiving unit 11 further receives, from the communication management apparatus 5, an operation restriction notification for restricting the operation on the display image and an operation restriction cancellation notification for canceling the restriction of the operation, for example. The transmitting and receiving unit 11 further transmits, to another electronic whiteboard 1, rendering screen data corresponding to an option, the selection of which is received by the receiving unit 12, for example.

The receiving unit 12 is implemented by a command from the CPU 101, the contact sensor 114, and the electronic pen controller 116 in FIG. 3 to receive various inputs made by the user with the electronic pen 190, for example.

The image and audio processing unit 13 is implemented by a command from the CPU 101 in FIG. 3 to perform a major process of a video conference function. For example, based on signals output from the microphone 140 and the camera 160, the image and audio processing unit 13 performs digital processing such as encoding of the site image data and the audio data. Further, for example, based on the site image data and the audio data received by the transmitting and receiving unit 11, the image and audio processing unit 13 generates an image signal and an audio signal. The image and audio processing unit 13 further performs a process of combining site image data items of different resolutions, for example.

The display control unit 14 is a function implemented by a command from the CPU 101 and the display controller 113 in FIG. 3 to perform control for outputting signals such as the image signal to the display 180. For example, the display control unit 14 controls the display 180 to display a rendering screen based on the rendering screen data generated by the image processing unit 16.

The determination unit 15 is a function implemented by a command from the CPU 101 in FIG. 3 to make various determinations.

The image processing unit 16 is a function implemented by a command from the CPU 101 and the capture device 111 in FIG. 3 to perform a major process of an electronic whiteboard function. The image processing unit 16 generates, for example, the stroke image and the stroke data based on the stroke made with the electronic pen 190, for example, and received by the receiving unit 12. The image processing unit 16 further generates, for example, the stroke image based on the stroke data received by the transmitting and receiving unit 11. The image processing unit 16 further generates the rendering screen data including the generated stroke image, for example. Further, for example, in response to receipt of the operation on the rendering screen during an operation restriction period, the image processing unit 16 generates a plurality of rendering screen data items in accordance with the received operation.

The near field communication unit 18 is a function implemented by a command from the CPU 101, the near field communication circuit 119, and the antenna 119a in FIG. 3 to provide data to or acquire data from another terminal having a near field communication unit, such as an integrated circuit (IC) card or a smartphone, in near field wireless communication.

The storing and reading unit 19 is a function implemented by a command from the CPU 101 in FIG. 3 to store various data in the storage unit 1000 and read therefrom various data. Each time the site image data and the audio data are received in the communication with another terminal, the site image data and audio data stored in the storage unit 1000 are overwritten with the newly received site image data and audio data. The display 180 displays an image based on the site image data before being overwritten with the newly-received site image data, and the speaker 150 outputs sound based on the audio data before being overwritten with the newly-received audio data. The storage unit 1000 further stores the stroke data of the stroke image rendered on the display 180 and the material image data of the material image displayed on the display 180.

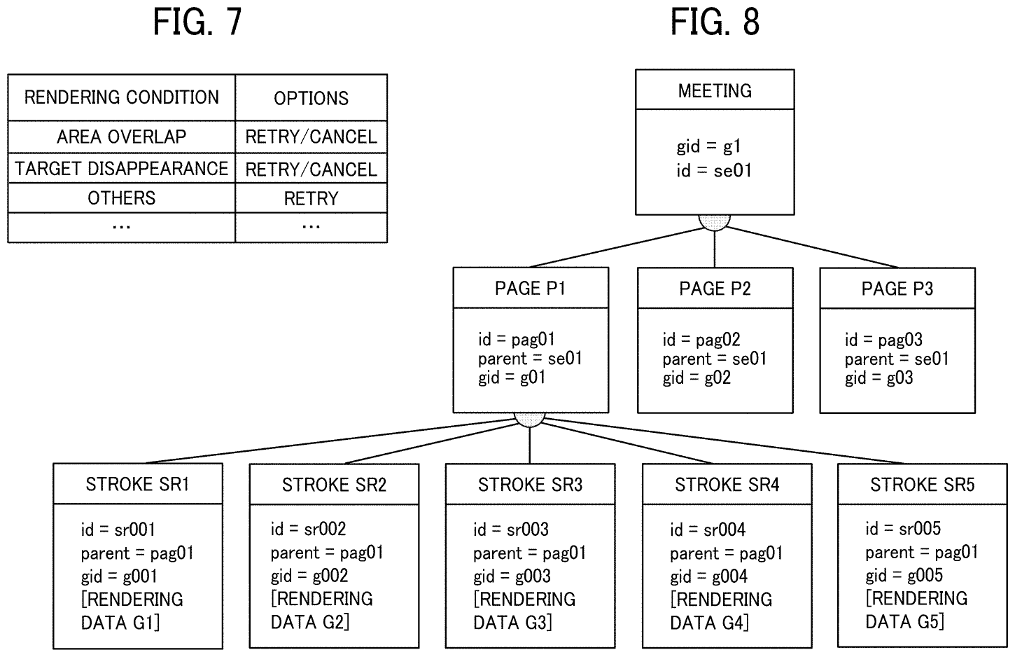

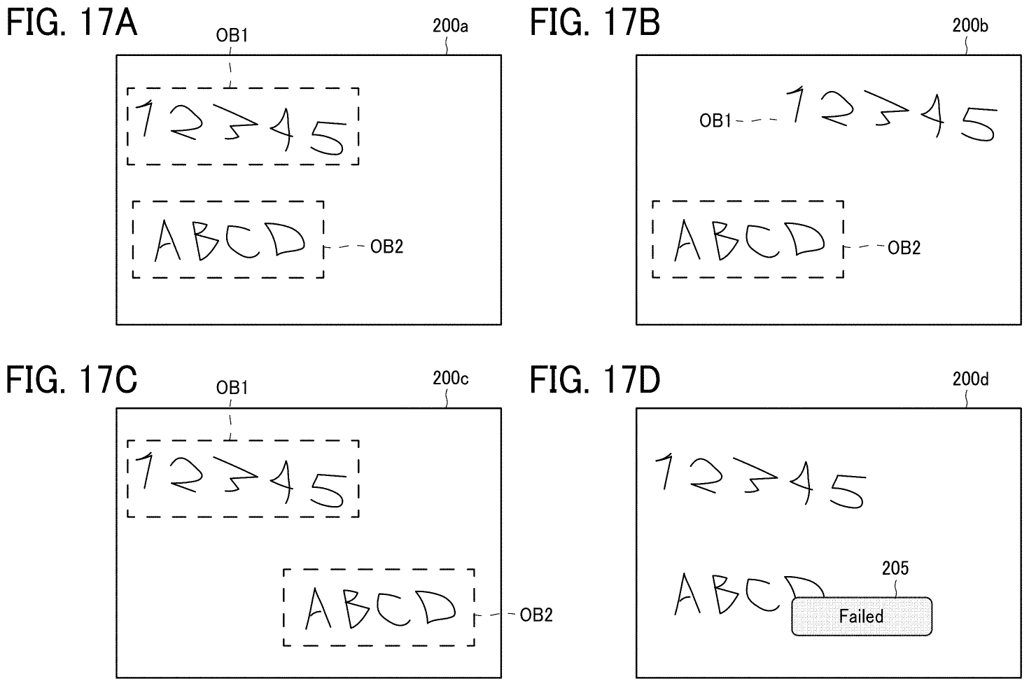

FIG. 7 is a conceptual diagram illustrating an example of a rendering condition management table of the embodiment. The storage unit 1000 stores a rendering condition management database (DB) 1001 configured as the rendering condition management table as illustrated in FIG. 7. In the rendering condition management table, options and a rendering condition for determining the rendering content of the display screen (i.e., the rendering screen) displayed on each of the electronic whiteboards 1 are managed in association with each other. Herein, the rendering condition represents the rendering content resulting from contention between the plurality of electronic whiteboards 1 for the operation on the rendering screen. The rendering condition includes “area overlap,” “target disappearance,” and “others,” for example. The rendering condition “area overlap” indicates that an operation has been performed on an overlapping area of the rendering screen shared by different electronic whiteboards 1. The rendering condition “target disappearance” indicates that an operation target operated by an electronic whiteboard 1 (e.g., an object OB1 or OB2 in FIGS. 17A to 17D) has disappeared on the rendering screen owing to the deletion of the operation target by another electronic whiteboard 1, for example. Further, the rendering condition “others” represents the rendering content corresponding to an operation other than those described in the rendering condition management table. For example, when the rendering condition is “area overlap” or “target disappearance” in the rendering condition management table of FIG. 7, the options are “retry” and “cancel.” When the rendering condition is “others,” the options are reduced to “retry.” In response to the operation received during the operation restriction period, therefore, the electronic whiteboard 1 provides the user with different options in accordance with the rendering content on the rendering screen. The rendering condition and the options in the rendering condition management table are not limited to the above-described examples, and may be set depending on whether inconsistency occurs at the time of retry or on the type of rendering content, for example.

FIG. 8 is a diagram schematically illustrating an example of rendering screen information of the embodiment. FIG. 8 illustrates an example of the conceptual image of the information of the rendering screen for display on the electronic whiteboard 1 stored in a rendering screen management DB 1003.

In the example of FIG. 8, the information of the rendering screen has a hierarchical structure with layers of information: “meeting,” “page” (i.e., pages P1 to P3), and “stroke” (i.e., strokes SR1 to SR5). Herein, “stroke” corresponds to the stroke data of the embodiment, and is managed under the corresponding “page.” Further, “page” represents one page of image (i.e., display image) displayed on the display 180. Page data representing “page” includes, for example, the stroke data and the image data of the material image displayed on the corresponding page. For instance, the stroke SR1 includes a stroke ID identifying the stroke SR1 (id=sr001), information identifying the corresponding parent page P1 (parent=pag01), a rendering data ID identifying the corresponding rendering data G1 (gid=g001), and the rendering data G1. If an operation such as a moving operation is performed on the stroke image data represented by the stroke SR1, for example, the stroke ID (id=sr001) is maintained, but the rendering data G1 and the rendering data ID identifying the rendering data G1 (gid=g001) are updated. The rendering data G1, which is rendering data for reproducing the stroke SR1, includes coordinate data, line width data, line color data, and vector data, for example.

The electronic whiteboard 1 is capable of switching between the pages, which correspond to the information “page.” For example, the page P1 includes information such as the page ID identifying the page P1 (id=pag01) and information identifying the corresponding parent information “meeting” (parent=se01).

The information “meeting” corresponds to the session managed by the communication system 10, and is managed with a session ID identifying the session (id=se01), for example. For instance, the image processing unit 16 of the electronic whiteboard 1 generates the stroke image rendered on the page P1 with the rendering data G1 to G5 included in the strokes SR1 to SR5.

A functional configuration of the relay apparatus 3 will be described with FIG. 6B. The relay apparatus 3 includes a transmitting and receiving unit 31, a determination unit 35, and a storing and reading unit 39. Each of these units is a function or a functional unit implemented when at least one of the components illustrated in FIG. 4 operates in response to a command from the CPU 301 in accordance with the relay program deployed on the RAM 303 from the HD 304. The relay apparatus 3 further includes a storage unit 3000 implemented by the RAM 303, the HD 304, or a recording medium 315 illustrated in FIG. 4.

The transmitting and receiving unit 31 is a function implemented by a command from the CPU 301 and the network I/F 309 in FIG. 4 to transmit and receive various data and information to and from another terminal, apparatus, or system via the communication network 100. The transmitting and receiving unit 31 also functions as a forwarding unit to forward the site image data and the audio data transmitted from a particular terminal to another terminal.

The determination unit 35 is a function implemented by a command from the CPU 301 in FIG. 4 to make various determinations such as a determination on a data delay state.

The storing and reading unit 39 is a function implemented by a command from the CPU 301 in FIG. 4 to store various data in the storage unit 3000 and read therefrom various data.

A functional configuration of the communication management apparatus 5 will be described with FIG. 6A.

The communication management apparatus 5 includes a transmitting and receiving unit 51, an authentication unit 52, a determination unit 53, a terminal managing unit 54, a session managing unit 55, a relay apparatus managing unit 56, a rendering screen information managing unit 57, an operation authority managing unit 58, and a storing and reading unit 59. Each of these units is a function or functional unit implemented when at least one of the components illustrated in FIG. 4 operates in response to a command from the CPU 501 in accordance with the communication management program deployed on the RAM 503 from the HD 504. The communication management apparatus 5 further includes a storage unit 5000 implemented by the RAM 503, the HD 504, or the recording medium 515 illustrated in FIG. 4.

The transmitting and receiving unit 51 is a function implemented by a command from the CPU 501 and the network I/F 509 in FIG. 4 to transmit and receive various data and information to and from another terminal or apparatus via the communication network 100. For example, the transmitting and receiving unit 51 receives the stroke data from one electronic whiteboard 1 and transmits the stroke data to another electronic whiteboard 1, and vice versa. Further, for example, the transmitting and receiving unit 51 receives an object operation request from each of the electronic whiteboards 1. The object operation request is a request for the operation on an object, which is a set of stroke data items.

The authentication unit 52 is a function implemented by a command from the CPU 501 in FIG. 4 to perform login authentication for a login requesting terminal. If the transmitting and receiving unit 51 receives login request information, the authentication unit 52 executes the login authentication process for the login requesting terminal with reference to an authentication management DB 5001.

The determination unit 53 is a function implemented by a command from the CPU 501 in FIG. 4 to make various determinations.

The terminal managing unit 54 is a function implemented by a command from the CPU 501 in FIG. 4 to manage various information of each of the electronic whiteboards 1 managed in a terminal management DB 5002 in accordance with the state of the electronic whiteboard 1. The terminal managing unit 54 updates the information of the terminal management DB 5002 such as an operation state, a reception time, and a terminal internet protocol (IP) address, for example. The terminal managing unit 54 further manages a destination list management DB 5003. In response to receipt of a request from one of the electronic whiteboards 1, the terminal managing unit 54 provides the electronic whiteboard 1 with destination list information including the terminal IDs of destination candidate terminals managed in the destination list management DB 5003.

The session managing unit 55 is a function implemented by a command from the CPU 501 in FIG. 4 to manage the session held in the communication system 10. For example, in response to receipt of start request information requesting the start of communication from one of the electronic whiteboards 1, the session managing unit 55 generates the session ID for identifying the session. Further, for example, the session managing unit 55 stores and manages various information of the session in a session management DB 5004 in association with the session ID.

The relay apparatus managing unit 56 is a function implemented by a command from the CPU 501 in FIG. 4. In the present embodiment, the communication system 10 includes one or more relay apparatuses 3. When the communication system 10 includes a plurality of relay apparatuses 3, the relay apparatus managing unit 56 selects one of the plurality of relay apparatuses 3 to be used for relaying the session. For example, the relay apparatus managing unit 56 manages a relay apparatus management DB 5005, and selects one of the plurality of relay apparatuses 3 based on various information of the relay apparatuses 3 stored in the relay apparatus management DB 5005. For example, based on the respective IP addresses of the relay apparatuses 3 stored in the relay apparatus management DB 5005 and the IP address of the starting terminal, the relay apparatus managing unit 56 selects one of the relay apparatuses 3 that is located near the starting terminal. Further, for example, the relay apparatus managing unit 56 selects one of the relay apparatuses 3 based on the respective maximum data transmission speeds of the relay apparatuses 3 stored in the relay apparatus management DB 5005. In the embodiment, a desired method may be employed to select the relay apparatus 3 for use in relaying the session.

The rendering screen information managing unit 57 is a function implemented by a command from the CPU 501 in FIG. 4 to manage various data of the rendering screen transmitted and received between the electronic whiteboards 1 (i.e., communication terminals). For example, the rendering screen information managing unit 57 receives the stroke data transmitted via the management information session SEI from one of the electronic whiteboards 1 participating in the session, and stores and manages the stroke data in a rendering screen information management DB 5006 in association with the session ID.

The operation authority managing unit 58 is a function implemented by a command from the CPU 501 in FIG. 4 to manage the operation authority over the rendering screen displayed on each of the electronic whiteboards 1. For example, based on an operation request transmitted from one of the electronic whiteboards 1, the operation authority managing unit 58 determines whether the electronic whiteboard 1 has the operation authority to operate the target data corresponding to the operation request.

The storing and reading unit 59 is a function implemented by a command from the CPU 501 in FIG. 4 to store various data in the storage unit 5000 and read therefrom various data.

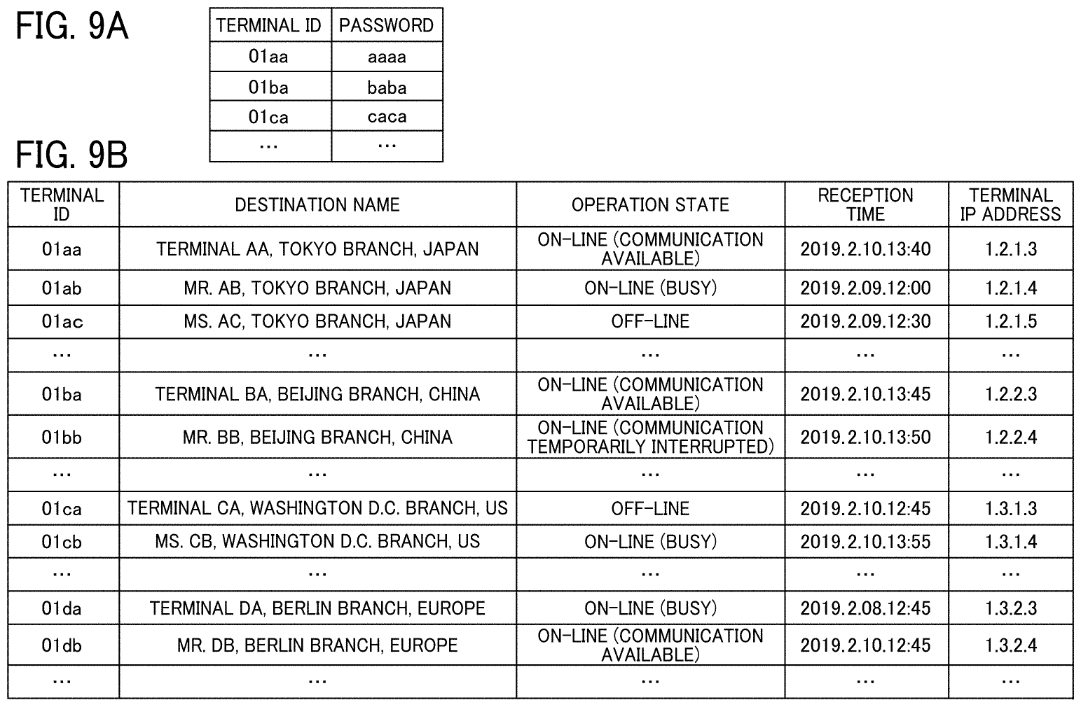

FIG. 9A is a conceptual diagram illustrating an example of an authentication management table of the embodiment. The storage unit 5000 stores the authentication management DB 5001 configured as the authentication management table as illustrated in FIG. 9A. In the authentication management table, the respective terminal IDs of all electronic whiteboards 1 managed by the communication management apparatus 5 are managed in association with respective passwords. For example, the authentication management table illustrated in FIG. 9A indicates that the electronic whiteboard 1a (i.e., a communication terminal) has a terminal ID “01aa” and a password “aaaa.” The password is an example of authentication information. An access token is also included in the authentication information.

FIG. 9B is a conceptual diagram illustrating an example of a terminal management table of the embodiment. The storage unit 5000 stores the terminal management DB 5002 configured as the terminal management table as illustrated in FIG. 9B. In the terminal management table, the destination name, the operation state, the reception time, and the terminal IP address are managed in association with each other for each terminal ID. The terminal ID identifies the corresponding electronic whiteboard 1 (i.e., a communication terminal). The destination name represents the name of the electronic whiteboard 1 as the destination. The operation state represents the operation state of the electronic whiteboard 1. The reception time represents the date and time of receipt of the login request information by the communication management apparatus 5. The terminal IP address represents the IP address of the electronic whiteboard 1 (i.e., a communication terminal). For example, the terminal management table in FIG. 9B indicates that the electronic whiteboard 1a with the terminal ID “01aa” has a destination name “TERMINAL AA, TOKYO BRANCH, JAPAN,” an operation state “ON-LINE (COMMUNICATION AVAILABLE),” a reception time of “13:40 on Feb. 10, 2019” as the date and time of receipt of the login request information by the communication management apparatus 5, and a terminal IP address “1.2.1.3” as the IP address of the terminal with the terminal ID “01aa.” The terminal ID, the destination name, and the terminal IP address are stored in the terminal management table when the electronic whiteboard 1 is previously registered to receive a service provided by the communication management apparatus 5.

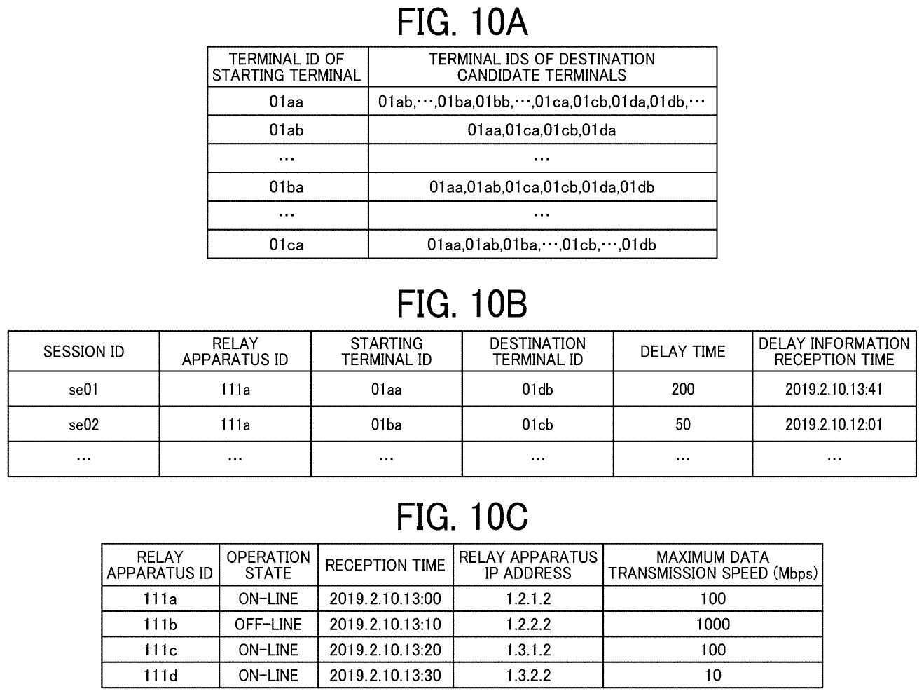

FIG. 10A is a conceptual diagram illustrating an example of a destination list management table of the embodiment. The storage unit 5000 stores the destination list management DB 5003 configured as the destination list management table as illustrated in FIG. 10A. In the destination list management table, the respective terminal IDs of all destination candidate terminals are managed in association with the terminal ID of the starting terminal. The starting terminal is the electronic whiteboard 1 that transmits a communication start request. The destination candidate terminals are the electronic whiteboards 1 registered as the candidates for the destination terminal corresponding to the starting terminal. For example, the destination list management table illustrated in FIG. 10A indicates that the destination candidate terminals to which the electronic whiteboard 1a with the terminal ID “01aa” (i.e., the starting terminal) is able to transmit the communication start request are electronic whiteboards 1 including the electronic whiteboard 1b with a terminal ID “01ba.” The destination candidate terminals in the destination list management table are updated when a destination candidate terminal is added to or deleted from the destination list management table in response to an addition request or a deletion request from a given starting terminal to the communication management apparatus 5.

The destination list is an example of destination information. In the destination information, the information of the destination candidate terminals such as the terminal IDs thereof may be arranged in a format other than the list format.

FIG. 10B is a conceptual diagram illustrating an example of a session management table of the embodiment. The storage unit 5000 stores the session management DB 5004 configured as the session management table as illustrated in FIG. 10B. In the session management table, the relay apparatus ID, the starting terminal ID, the destination terminal ID, the delay time, and the delay information reception time are managed in association with each other for each session ID. The session ID identifies the session for implementing the communication between the relay apparatus 3 and the electronic white boards 1 (i.e., communication terminals). The relay apparatus ID is the apparatus ID of the relay apparatus 3 used in the session. The starting terminal ID is the terminal ID of the electronic white board 1 serving as the starting terminal. The destination terminal ID is the terminal ID of the electronic white board 1 serving as the destination terminal. The delay time represents the delay time (milliseconds) in the reception of the site image data by the destination terminal. The delay information reception time represents the date and time of receipt of delay information by the communication management apparatus 5. The delay information, which represents the delay time, is transmitted from the destination terminal. For example, the session management table illustrated in FIG. 10B indicates that the relay apparatus 3 with a relay apparatus ID “111a” relays the site image data and the audio data between an electronic white board 1 with a terminal ID “01aa” and an electronic white board 1 with a terminal ID “01db” in a communication session executed with a session ID “se01.” The session management table further indicates that the delay time of the site image data in the electronic white board 1 serving as the destination terminal is 200 milliseconds at “13:41 on Feb. 10, 2019.”

FIG. 10C is a conceptual diagram illustrating an example of a relay apparatus management table of the embodiment. The storage unit 5000 stores the relay apparatus management DB 5005 configured as the relay apparatus management table as illustrated in FIG. 10C. In the relay apparatus management table, the operation state of each relay apparatus 3, the time of receipt of state information by the communication management apparatus 5, the IP address of the relay apparatus 3, and the maximum data transmission speed (megabits per second: Mbps) of the relay apparatus 3 are managed in association with each other for each relay apparatus ID. The relay apparatus ID represents the relay apparatus ID of the corresponding relay apparatus 3. The state information includes information such as the operation state. For example, the relay apparatus management table illustrated in FIG. 10C indicates that the operation state of the relay apparatus 3 with a relay apparatus ID “111a” is “ON-LINE,” and that the time of receipt of the state information by the communication management apparatus 5 is “13:00 on Feb. 10, 2019.” The relay apparatus management table further indicates that the relay apparatus 3 has an IP address “1.2.1.2” and a maximum data transmission speed of 100 Mbps.

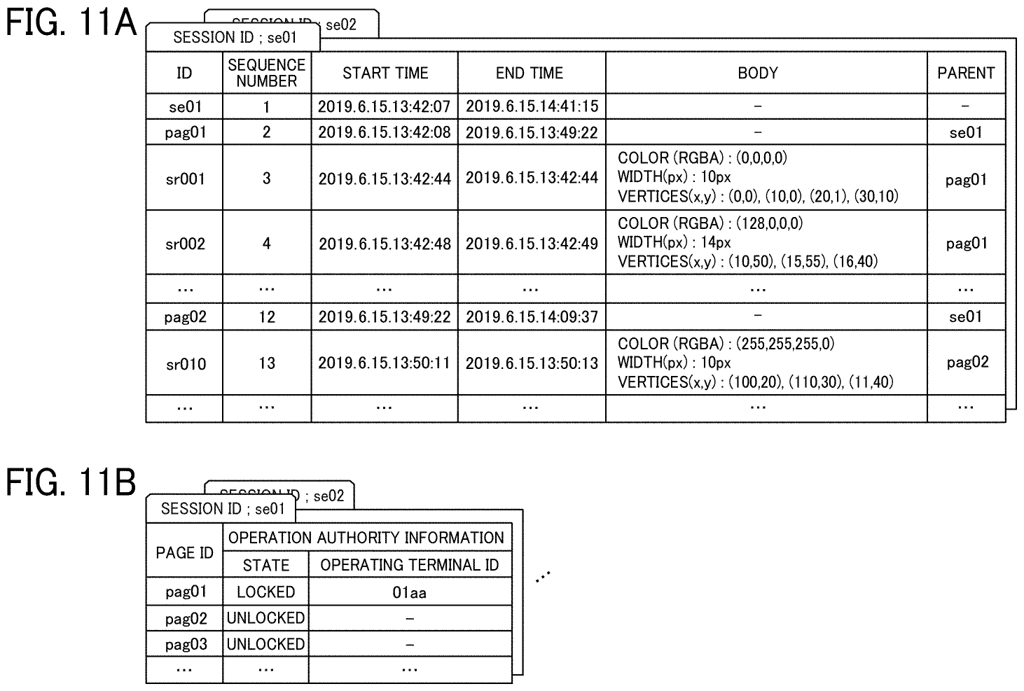

FIG. 11A is a conceptual diagram illustrating an example of a rendering screen information management table of the embodiment. The storage unit 5000 stores the rendering screen information management DB 5006 configured as the rendering screen information management table as illustrated in FIG. 11A. In the rendering screen information management table, various data related to the rendering screen shared by the electronic whiteboards 1 (i.e., communication terminals) is stored and managed for each session ID identifying the session for implementing the communication between the electronic whiteboards 1 and the relay apparatus 3. The data of the rendering screen information management table corresponds to the information of the rendering screen stored in the rendering screen management DB 1003 of each of the electronic whiteboards 1 (see FIG. 8). The data of the rendering screen information management table includes an ID identifying the corresponding data item, a sequence number of the data item, a start time and an end time of a process for the data item, information “BODY” representing the contents of the data item, and information “PARENT” identifying the parent data of the data item. For example, in the case of the stroke data, the rendering screen information management table includes a stroke ID identifying stroke data generated by a stroke rendering event, a start time representing the time of starting a stroke, an end time representing the time of finishing the stroke, information representing the contents of the stroke data, and information identifying page data as the parent data of the stroke data. In this case, the information “BODY” representing the contents of the stroke data includes information of color, width, and vertices. The color represents the color of the rendered stroke. The width represents the thickness of the line of the rendered stroke. The vertices represent the respective coordinates (x, y) of the vertices of the rendered stroke.

Herein, the stroke rendering refers to a process of inputting the rendering information performed by the user. For example, the stroke rendering is an event in which the user presses the electronic pen 190 against the display 180, moves the electronic pen 190 while in contact with the display 180, and releases the electronic pen 190 from the display 180. The color of the stroke is expressed by numerical values each ranging from 0 to 25 to represent the corresponding color component in the red-green-blue-alpha (RGBA) data format. The width representing the thickness of the line of the rendered stroke is represented by the number of pixels. Each of the vertices of the rendered stroke is represented by the XY coordinates. The vertices are connected together by a Bezier curve to form a line segment representing the stroke. With the rendering screen information management table, the communication management apparatus 5 manages the various data of the rendering screen including the stroke data generated in a video conference using a particular communication session, for example.

FIG. 11B is a conceptual diagram illustrating an example of an operation authority management table of the embodiment. The storage unit 5000 stores an operation authority management DB 5007 configured as the operation authority management table as illustrated in FIG. 11B. In the operation authority management table, a page ID and operation authority information are managed in association with each other for each session ID that identifies the session for implementing the communication between the electronic whiteboards 1 (i.e., communication terminals) and the relay apparatus 3. The page ID identifies the corresponding page. The operation authority information represents the operation authority set for the page. The operation authority information includes information of the operation authority for each page on a screen displayed on the electronic whiteboard 1. The operation authority information includes the state of the operation authority (hereinafter referred to as the operation authority state). When the operation authority state is described as “LOCKED,” the operation authority is set for the corresponding page. When the operation authority state is described as “UNLOCKED,” the operation authority is not set for the corresponding page. The operation authority information further includes information of an operating terminal, i.e., the electronic whiteboard 1 having the operation authority over the page corresponding to the operation authority state “LOCKED.” For example, in the operation authority management table of FIG. 11B, a page ID “pag01” is associated with the operation authority state “LOCKED” and an operation terminal ID “01aa” as the operation authority information, indicating that the operation authority over the page P1 is limited to the electronic whiteboard 1a with the terminal ID “01aa.”

A functional configuration of the image storing apparatus 7 will be described with FIG. 6B.

The image storing apparatus 7 includes a transmitting and receiving unit 71 and a storing and reading unit 79. Each of these units is a function or functional unit implemented when at least one of the components illustrated in FIG. 4 operates in response to a command from the CPU 701 in accordance with the image storage program deployed on the RAM 703 from the HD 704. The image storing apparatus 7 further includes a storage unit 7000 implemented by the RAM 703, the HD 704, or a recording medium 715 illustrated in FIG. 4.

The transmitting and receiving unit 71 is a function implemented by a command from the CPU 701 and the network I/F 709 in FIG. 4 to transmit and receive various data and information to and from another terminal or apparatus via the communication network 100.

The storing and reading unit 79 is a function implemented by a command from the CPU 701 in FIG. 4 to store various data in the storage unit 7000 and read therefrom various data.

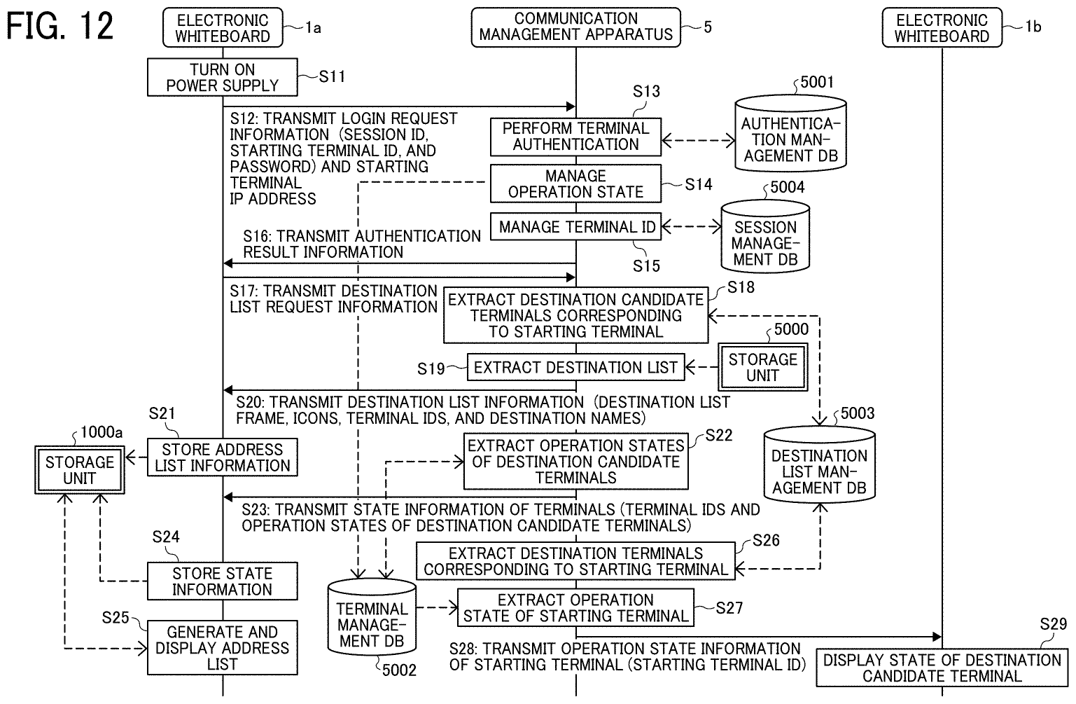

Processes and operations performed in the communication system 10 of the embodiment will be described with FIG. 12 to FIGS. 23A to 23D.

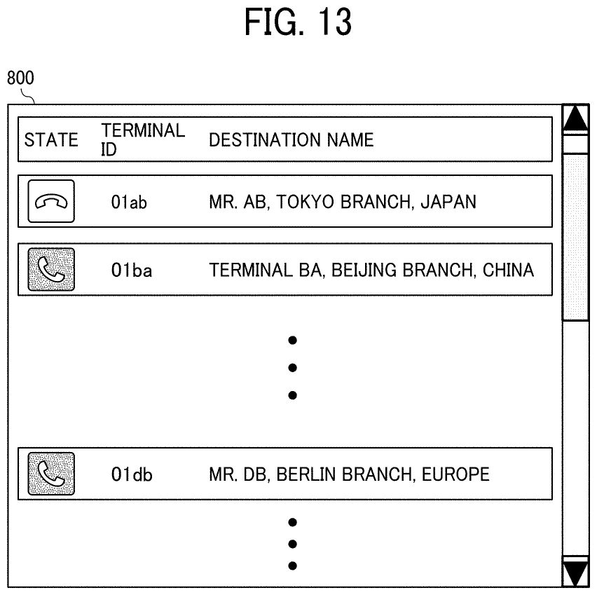

A preparatory process (i.e., a login request process) for remote communication performed by the electronic whiteboard 1a as the login requesting terminal will first be described with FIGS. 12 and 13. The electronic whiteboard 1b performs a login request process similar to that performed by the electronic whiteboard 1a, and thus description thereof will be omitted.

FIG. 12 is a sequence diagram illustrating an example of a preparatory process for starting remote communication between the electronic whiteboards 1. FIG. 13 is a diagram illustrating an example of a destination list screen displayed on the electronic whiteboards 1.

When the power switch 122 of the electronic whiteboard 1a is turned on, the receiving unit 12a receives the power-on operation (step S11).

The transmitting and receiving unit 11a of the electronic whiteboard 1a then transmits the login request information to the communication management apparatus 5 via the communication network 100 (step S12). The login request information, which represents the request for login authentication, includes the terminal ID of the electronic whiteboard 1a and the password. The terminal ID and the password are data read from the storage unit 1000a and transmitted to the transmitting and receiving unit 11a by the storing and reading unit 19a. The terminal ID and the password are not necessarily read from the storage unit 1000a, and may be input by the user with an input device such as a keyboard, or may be read from a recording medium connected to the electronic whiteboard 1a, a such as a subscriber identify module (SIM) card or a secure digital (SD) card. Then, the transmitting and receiving unit 51 of the communication management apparatus 5 receives the login request information transmitted from the electronic whiteboard 1a.

Then, the authentication unit 52 of the communication management apparatus 5 performs a search through the authentication management table (see FIG. 9A) with search keys set to the terminal ID and the password included in the login request information received via the transmitting and receiving unit 51. If the same terminal ID and password as those included in the login request information are managed in the authentication management table, the authentication unit 52 allows login of the electronic whiteboard 1a (step S13), and the processes of step S14 and the subsequent steps are executed.

If the login of the electronic whiteboard 1a is allowed, the terminal managing unit 54 updates the information of the terminal management table (see FIG. 9B), specifically the information corresponding to the terminal ID “01aa” of the electronic whiteboard 1a. For example, the terminal managing unit 54 changes the information of the operation state corresponding to the terminal ID “01aa” to “ON-LINE (COMMUNICATION AVAILABLE),” and updates the information of the reception time to the date and time of receipt of the login request information (step S14). The terminal IP address in the terminal management table may be transmitted from the electronic whiteboard 1a at step S12 instead of being previously registered therein. Thereby, the operation state “ON-LINE (COMMUNICATION AVAILABLE),” the reception time “13:40 on Feb. 10, 2019,” and the IP address “1.2.1.3” are managed in the terminal management table in association with the terminal ID “01aa,” as illustrated in FIG. 9B, for example.

Then, the session managing unit 55 adds a new record to the session management table (see FIG. 10B) and manages the new record (step S15). In the new record, the terminal ID “01aa” of the electronic whiteboard 1a received at step S12 is managed as the starting terminal ID. Then, the transmitting and receiving unit 51 transmits authentication result information to the electronic whiteboard 1a (i.e., the source of the login request information) via the communication network 100 (step S16). The authentication result information represents an authentication result obtained through the process of step S13.

In response to receipt of the authentication result information indicating that the login of the electronic whiteboard 1a is allowed, the transmitting and receiving unit 11a of the electronic whiteboard 1a (i.e., the login requesting terminal) transmits destination list request information to the communication management apparatus 5 via the communication network 100 (step S17). The destination list request information represents the request for the destination list. Then, the transmitting and receiving unit 51 of the communication management apparatus 5 receives the destination list request information.

Then, the terminal managing unit 54 performs a search through the destination list management table (see FIG. 10A) with a search key set to the terminal ID “01aa” of the electronic whiteboard 1a (i.e., the login requesting terminal), to thereby read from the destination list management table the terminal IDs of the destination candidate terminals that are capable of communicating with the electronic whiteboard 1a. The terminal managing unit 54 further reads, from the terminal management table (see FIG. 9B), the destination names corresponding to the terminal IDs of the destination candidate terminals (step S18). In the present example, the terminal managing unit 54 extracts the terminal IDs of the destination candidate terminals corresponding to the terminal ID “01aa” of the electronic whiteboard 1a and the destination names corresponding to the terminal IDs.

Then, the transmitting and receiving unit 51 reads, via the storing and reading unit 59, the data of a destination list frame and icons representing the operation states from the storage unit 5000, for example (step S19). The transmitting and receiving unit 51 further transmits the destination list information to the electronic whiteboard 1a (step S20). The destination list information includes the read destination list frame and icons and the terminal IDs and the destination names extracted at step S18. That is, the destination list information includes the destination list frame, the icons, the terminal IDs, and the destination names. Then, in the electronic whiteboard 1a, the transmitting and receiving unit 11a receives the destination list information, and the storing and reading unit 19a stores the received destination list information in the storage unit 1000a (step S21).

In the present embodiment, the communication management apparatus 5 thus centrally manages the destination list information of all electronic whiteboards 1, instead of each of the electronic whiteboards 1 managing the destination list information. In the communication system 10 of the present embodiment, therefore, the communication management apparatus 5 centrally responds to changes such as the addition of a new electronic whiteboard 1 to the communication system 10, the replacement of any of the electronic whiteboards 1 in the communication system 10 with a new electronic whiteboard 1, and a change in the appearance of the destination list frame. Consequently, the electronic whiteboards 1 are saved from a process of changing the destination list information.

The terminal managing unit 54 further performs a search through the terminal management table (see FIG. 9B) with search keys set to the terminal IDs of the destination candidate terminals extracted at step S18, to thereby read from the terminal management table the respective operation states corresponding to the terminal IDs of the destination candidate terminals. Thereby, the terminal managing unit 54 acquires the respective operation states of the electronic whiteboards 1 corresponding to the terminal IDs of the destination candidate terminals (step S22).

The transmitting and receiving unit 51 then transmits terminal state information to the electronic whiteboard 1a via the communication network 100 (step S23). The terminal state information includes the terminal IDs used as the search keys at step S22 and the respective operation states of the electronic whiteboards 1 as the destination candidate terminals corresponding to the terminal IDs.

Then, the storing and reading unit 19a of the electronic whiteboard 1a sequentially stores, in the storage unit 1000a, the items of the terminal state information received from the communication management apparatus 5 (step S24). The electronic whiteboard 1a thereby receives the terminal state information of each of the electronic whiteboards 1 as the destination candidate terminals, and thus acquires the current operation states of the destination candidate terminals, i.e., the other electronic whiteboards 1 such as the electronic whiteboard 1b capable of communicating with the electronic whiteboard 1a.

Then, based on the destination list information and the terminal state information stored in the storage unit 1000a, the display control unit 14a generates the destination list reflecting the states of the destination candidate terminals. Further, with the generated destination list, the display control unit 14a controls the display 180 of the electronic whiteboard 1a to display a destination list screen 800 as illustrated in FIG. 13 (step S25). The destination list screen 800 displays, for each of the destination candidate terminals, the icon representing the operation state of the destination candidate terminal and the terminal ID and the destination name of the destination candidate terminal. In the example of FIG. 13, the icon representing the operation state of the destination candidate terminal is displayed as an “OFF-LINE” icon in an upper part of the destination list screen 800 and as an “ON-LINE (COMMUNICATION AVAILABLE)” icon in a middle part and a lower part of the destination list screen 800.

In the communication management apparatus 5, the terminal managing unit 54 performs a search through the destination list management table (see FIG. 10A) based on the terminal ID “01aa” of the electronic whiteboard 1a, to thereby extract from the destination list management table the terminal IDs of the other electronic whiteboards 1 in which the electronic whiteboard 1a is registered as a destination candidate terminal (step S26). In the destination list management table in FIG. 10A, terminal IDs “01ba,” “01ca,” and “01da” are among the terminal IDs of the other electronic whiteboards 1 read in this step.

The terminal managing unit 54 then performs a search through the terminal management table (see FIG. 9B) based on the terminal ID “01aa” of the electronic whiteboard 1a, to thereby acquire the operation state of the electronic whiteboard 1a from the terminal management table (step S27).

Then, the transmitting and receiving unit 51 transmits terminal state information to the electronic whiteboards 1 corresponding to the terminal IDs extracted at step S26 and corresponding to the operation state “ON-LINE” in the terminal management table (see FIG. 9B) (step S28). The terminal state information in this case includes the terminal ID “01aa” of the electronic whiteboard 1a and the operation state “ON-LINE” of the electronic whiteboard 1a acquired at step S27. When transmitting the terminal state information to the other electronic whiteboards 1 such as the electronic whiteboard 1b, the transmitting and receiving unit 51 refers to the IP addresses of the electronic whiteboards 1 managed in the terminal management table (see FIG. 9B) based on the terminal IDs of the electronic whiteboards 1. Thereby, the transmitting and receiving unit 51 transmits the terminal ID “01aa” and the operation state “ON-LINE” of the electronic whiteboard 1a to each of the other electronic whiteboards 1 capable of communicating with the electronic whiteboard 1a, which is a destination candidate terminal for the other electronic whiteboards 1. Consequently, each of the destination candidate terminals (i.e., the other electronic whiteboards 1 such as the electronic whiteboard 1b) also displays, on the display 180 thereof, the state of the electronic whiteboard 1a (i.e., a destination candidate terminal for the other electronic whiteboards 1 such as the electronic whiteboard 1b) (step S29).

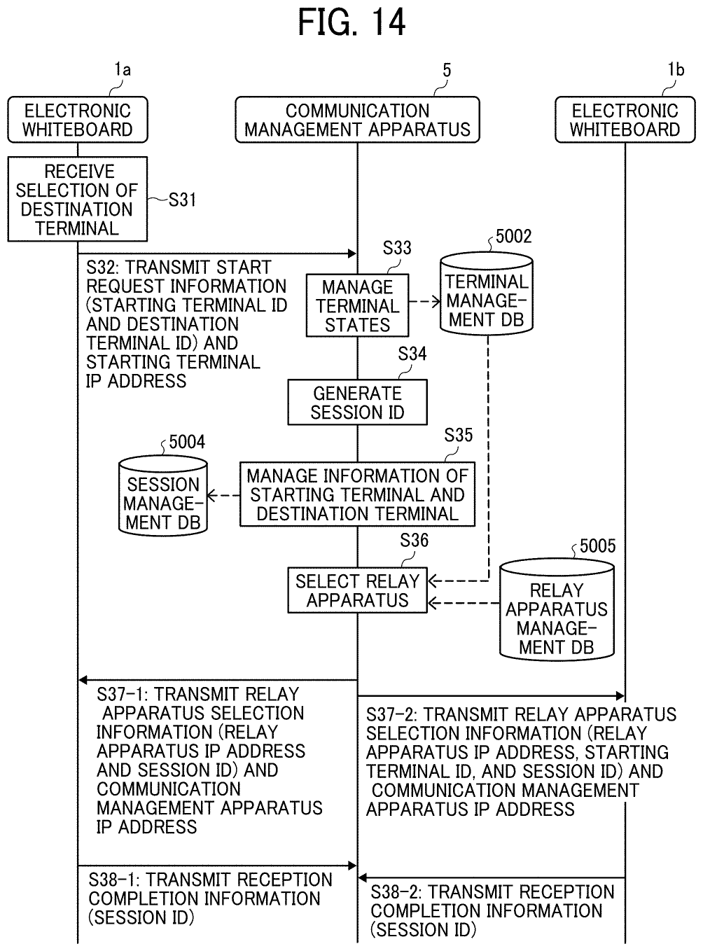

With reference to FIG. 14 a description will be given of a process in which the electronic whiteboard 1a starts remote communication with the electronic whiteboard 1b.

FIG. 14 is a sequence diagram illustrating an example of a process of starting remote communication. When the user UA1 of the electronic whiteboard 1a (i.e., the starting terminal) selects the electronic whiteboard 1b (i.e., the destination terminal) by pressing a field in the destination list screen 800 in FIG. 13 corresponding to the terminal ID “01ba” of the electronic whiteboard 1b, the receiving unit 12a receives the user request to start the communication with the electronic whiteboard 1b (i.e., the destination terminal) (step S31). Then, the transmitting and receiving unit 11a of the electronic whiteboard 1a (i.e., the starting terminal) transmits the start request information to the communication management apparatus 5 (step S32). The start request information, which represents the request to start the communication, includes the terminal ID “01aa” of the electronic whiteboard 1a (i.e., the starting terminal) and the terminal ID “01ba” of the electronic whiteboard 1b (i.e., the destination terminal). Then, the transmitting and receiving unit 51 of the communication management apparatus 5 receives the start request information and the IP address of the electronic whiteboard 1a (i.e., the starting terminal) as the source of the start request information.

Then, the terminal managing unit 54 updates the terminal management table (see FIG. 9B) based on the terminal ID “01aa” of the electronic whiteboard 1a (i.e., the starting terminal) and the terminal ID “01ba” of the electronic whiteboard 1b (i.e., the destination terminal) included in the start request information (step S33). For example, based on the terminal ID “01aa” of the electronic whiteboard 1a (i.e., the starting terminal) and the terminal ID “01ba” of the electronic whiteboard 1b (i.e., the destination terminal) included in the start request information, the terminal managing unit 54 updates the respective operation states corresponding to the terminal IDs “01aa” and “01ba” in the terminal management table to “ON-LINE (BUSY).” The information of the electronic whiteboard 1a (i.e., the starting terminal) and the electronic whiteboard 1b (i.e., the destination terminal) managed in the terminal management table in this state indicates that the electronic whiteboards 1a and 1b have not participated in a communication session yet but are in a communicating state. That is, the electronic whiteboard 1a (i.e., the starting terminal) and the electronic whiteboard 1b (i.e., the destination terminal) have not started a video conference yet, but are in the communicating state. Therefore, if a user of another electronic whiteboard 1 (e.g., a user of another electronic whiteboard 1 intending to join the communication) attempts to communicate with the electronic whiteboard 1a (i.e., the starting terminal) or the electronic whiteboard 1b (i.e., the destination terminal) in this state, the another electronic whiteboard 1 outputs a notification sound or displays a message to notify the user that the intended electronic whiteboard 1a or 1b is busy on another line.

A description will be given of a process of executing a communication session to select the relay apparatus 3 to be actually used.

The session managing unit 55 of the communication management apparatus 5 first generates the session ID for identifying the communication session to be held between the electronic whiteboards 1a and 1b (step S34). It is assumed here that the session ID “se01” is generated.

The session managing unit 55 then stores and manages the session ID “se01” generated at step S34, the terminal ID “01aa” of the electronic whiteboard 1a (i.e., the starting terminal), and the terminal ID “01ba” of the electronic whiteboard 1b (i.e., the destination terminal) in the session management table (see FIG. 10B) in association with each other (step S35).

Then, the relay apparatus managing unit 56 selects the relay apparatus 3 that relays the communication session between the electronic whiteboard 1a (i.e., the starting terminal) and the electronic whiteboard 1b (i.e., the destination terminal) (step S36). For example, the relay apparatus managing unit 56 selects, from the relay apparatuses 3 with relay apparatus IDs corresponding to the operation state “ON-LINE” in the relay apparatus management table (see FIG. 10C), the relay apparatus 3 having an IP address close to the IP address of the electronic whiteboard 1a (i.e., the starting terminal) in the terminal management table (see FIG. 9B). It is assumed in the following description that the relay apparatus 3 with a relay apparatus ID “111a” has been selected.

After the completion of the process of step S36 to select the relay apparatus 3, the transmitting and receiving unit 51 of the communication management apparatus 5 transmits relay apparatus selection information to the electronic whiteboard 1a (i.e., the starting terminal) (step S37-1). The relay apparatus selection information includes the IP address of the relay apparatus 3 selected at step S36 and the session ID “se01” generated at step S34. Then, the electronic whiteboard 1a (i.e., the starting terminal) acquires the IP address of the communication management apparatus 5 as the source of the relay apparatus selection information.

The transmitting and receiving unit 51 of the communication management apparatus 5 further transmits relay apparatus selection information to the electronic whiteboard 1b (i.e., the destination terminal) (step S37-2). The relay apparatus selection information includes the IP address of the relay apparatus 3 selected at step S36, the terminal ID “01aa” of the electronic whiteboard 1a (i.e., the starting terminal), and the session ID “se01” generated at step S34. In the execution of the commutation session with the session ID “se01,” therefore, the electronic whiteboard 1b (i.e., the destination terminal) acquires the IP address of the communication management apparatus 5 as the source of the relay apparatus selection information.

Then, the transmitting and receiving unit 11a of the electronic whiteboard 1a (i.e., the starting terminal) transmits reception completion information to the communication management apparatus 5 (step S38-1). The reception completion information indicates that the relay apparatus selection information transmitted in the process of step S37-1 has been received. The reception completion information includes the session ID transmitted in the process of step S37-1. Then, the communication management apparatus 5 acquires information indicating that the transmission of the relay apparatus selection information executed in a particular communication session with the session ID “se01” has been completed.

The electronic whiteboard 1b (i.e., the destination terminal) similarly transmits to the communication management apparatus 5 reception completion information indicating that the relay apparatus selection information transmitted in the process of step S37-2 has been received (step S38-2). In this case, too, the communication management apparatus 5 acquires information indicating that the transmission of the relay apparatus selection information executed in the particular communication session with the session ID “se01” has been completed.

Via the relay apparatus 3 selected at step S36, the electronic whiteboards 1a and lb transmit and receive the site image data and the audio data to and from each other to have the video conference.

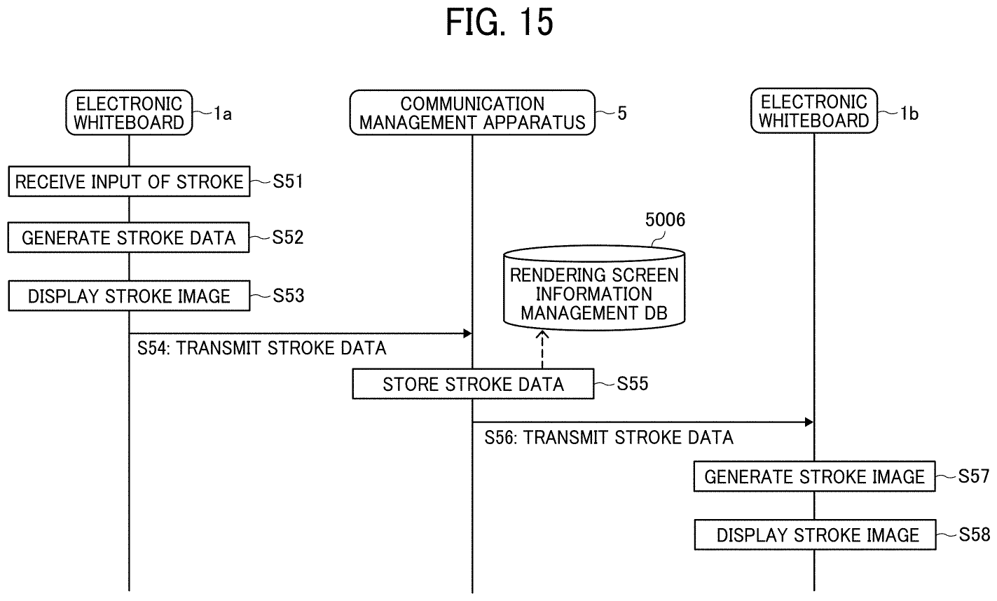

A process of sharing the stroke image between the plurality of electronic whiteboards 1 will be described with FIG. 15.

In the communication system 10 of the embodiment, when the user UA1 of the electronic whiteboard 1a and the users UB1 and UB2 of the electronic whiteboard 1b are participating in the video conference, the stroke image rendered on one of the electronic whiteboards 1a and 1b by a user with the electronic pen 190, for example, is displayed on the other one of the electronic whiteboards 1a and 1b as an image for sharing.

The following description will be given of an exemplary process in which the electronic whiteboards 1a and 1b participating in the same communication session share the stroke image (i.e., stroke data).

FIG. 15 is a sequence diagram illustrating an example of a stroke data sharing process of the embodiment. It is assumed here that, at the start of the process of FIG. 15, the electronic whiteboards 1a and 1b are participating in the same communication session based on the process of FIG. 14 to start the communication session. It is also assumed that the electronic whiteboards 1a and 1b share the material image via the image storing apparatus 7 and displays the material image on the display 180 as necessary.

When the user UA1 performs rendering by moving the electronic pen 190 or the hand H in contact with the display 180 of the electronic whiteboard 1 a, the receiving unit 12a receives the input of the rendered stroke (i.e., trajectory) (step S51). The image processing unit 16a of the electronic whiteboard 1a generates stroke data for displaying a stroke image according to the stroke received by the receiving unit 12a (step S52).

Based on the stroke data generated by the image processing unit 16a, the display control unit 14a of the electronic whiteboard 1a displays the stroke image on the display 180 (step S53). Thereby, the stroke image rendered on the display 180 by the user UA1 with the electronic pen 190, for example, is displayed on the display 180.

Then, the transmitting and receiving unit 11a of the electronic whiteboard 1a transmits the stroke data for reproducing the stroke image rendered by the user UA1 to the communication management apparatus 5 via the management information session SEI, for example (step S54). Then, the transmitting and receiving unit 51 of the communication management apparatus 5 receives the stroke data transmitted from the electronic whiteboard 1a.

The rendering screen information managing unit 57 of the communication management apparatus 5 stores the stroke data received from the electronic whiteboard 1a in the rendering screen information management table as illustrated in FIG. 11A, for example (step S55). The rendering screen information managing unit 57 of the communication management apparatus 5 then forwards the stroke data to the electronic whiteboard 1b participating in the communication session participated by the electronic whiteboard 1a (step S56). Then, the transmitting and receiving unit 11b of the electronic whiteboard 1b receives the stroke data.

The image processing unit 16b of the electronic whiteboard 1b generates the stroke image based on the stroke data received by the transmitting and receiving unit 11b (step S57). Then, the display control unit 14b controls the display 180 to display the stroke image generated by the image processing unit 16b, i.e., the stroke image rendered by the user UA1 at step S51 (step S58).

The electronic whiteboards 1a and 1b participating in the same communication session thus share the stroke image. When the user UB1 or UB2 performs rendering on the electronic whiteboard 1b with the electronic pen 190, for example, the stroke image is similarly displayed on the electronic whiteboard 1a.

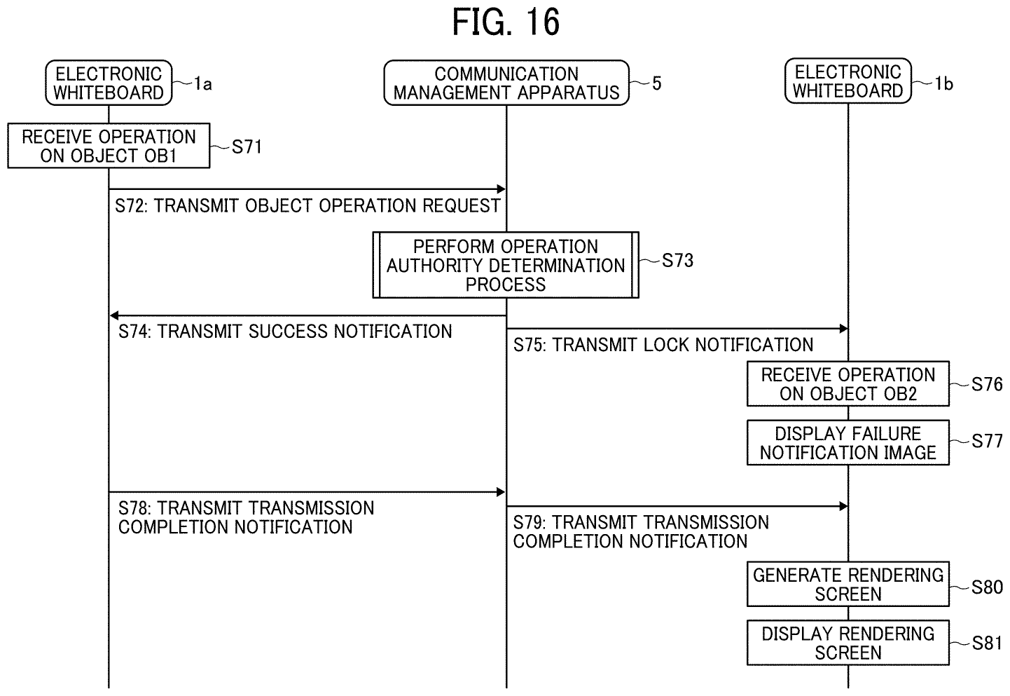

A process of performing rendering on the electronic whiteboard 1 in accordance with the operation restriction will be described with FIG. 16 to FIGS. 23A to 23D.

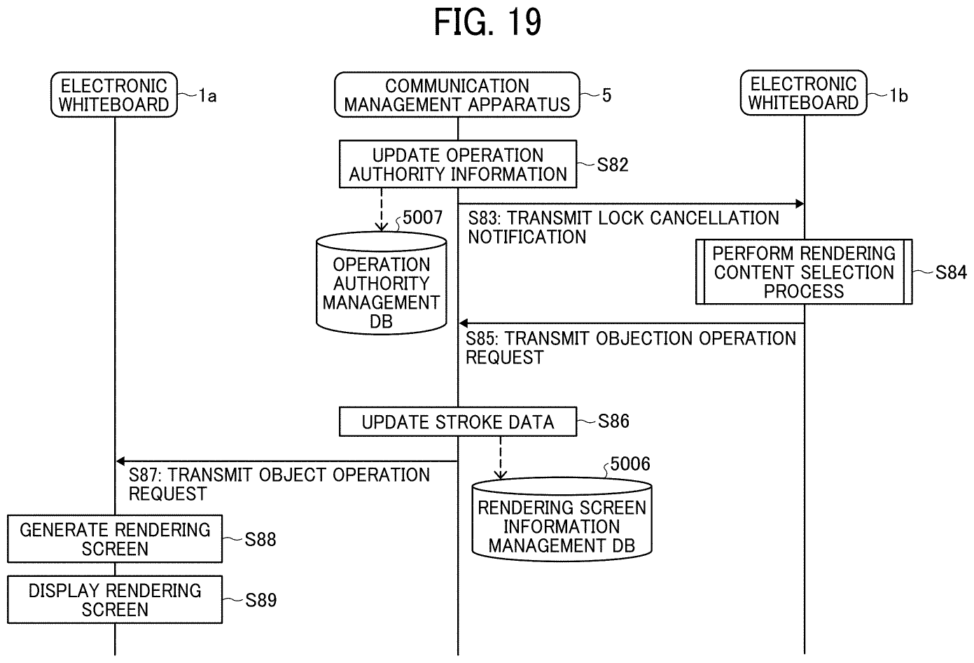

FIGS. 16 and 19 are sequence diagrams illustrating an example of the process of performing rendering on the electronic whiteboard 1 in accordance with the operation restriction in the communication system 10 of the embodiment. It is assumed here that a rendering screen 200a as illustrated in FIG. 17A is displayed on the display 180 of each of the electronic whiteboards 1a and 1b.

The rendering screen 200a illustrated in FIG. 17A includes an object OB1 and an object OB2, each of which is a set of stroke data items, for example, which are rendered through the process illustrated in FIG. 15. Herein, an object may be a stroke formed with a sequence of connected coordinate points, text obtained by optical character reader (OCR)-processing on strokes into letters, characters, or symbols such as numerical symbols, a system-generated character representing the date or time, a particular figure such as a triangle, a star, or a circle, an image usable in a particular application program such as a pictorial symbol or an illustration, an arrow, a line segment, or a line such as a Bezier curve, for example. Such information displayed on the display 180 based on the rendering operation by a user is referred to as an object. In the following description, the objects OB1 and OB2 displayed on the rendering screen 200a are assumed to be rendered on the page P1.

When the user UA1 of the electronic whiteboard 1a moves the object OB1 on the rendering screen 200a with the electronic pen 190, for example, the receiving unit 12a receives the user operation performed on the object OB1 (step S71). For example, the user UA1 moves the object OB1 on the rendering screen 200a toward the upper-right side of the rendering screen 200a to obtain a rendering screen 200b illustrated in FIG. 17B. Then, the transmitting and receiving unit 11a transmits to the communication management apparatus 5 an object operation request that requests the operation on an object rendered on the page P1 (step S72). Then, the transmitting and receiving unit 51 of the communication management apparatus 5 receives the object operation request transmitted from the electronic whiteboard 1a.

The operation on the object (also referred to as the object operation) is not limited to moving the object. Thus, the object operation may be editing the object such as zooming-in, zooming-out, or deleting the object, adding or deleting a stroke, or converting the hue. In the following description, the operation on the rendering screen is assumed to be the operation on an object displayed on the rendering screen. The operation on the rendering screen, however, may be the operation on a stroke displayed on the rendering screen.

Then, based on the object operation request received by the transmitting and receiving unit 51, the communication management apparatus 5 executes a process of determining whether the operation authority is set (hereinafter referred to as the operation authority determination process) (step S73).

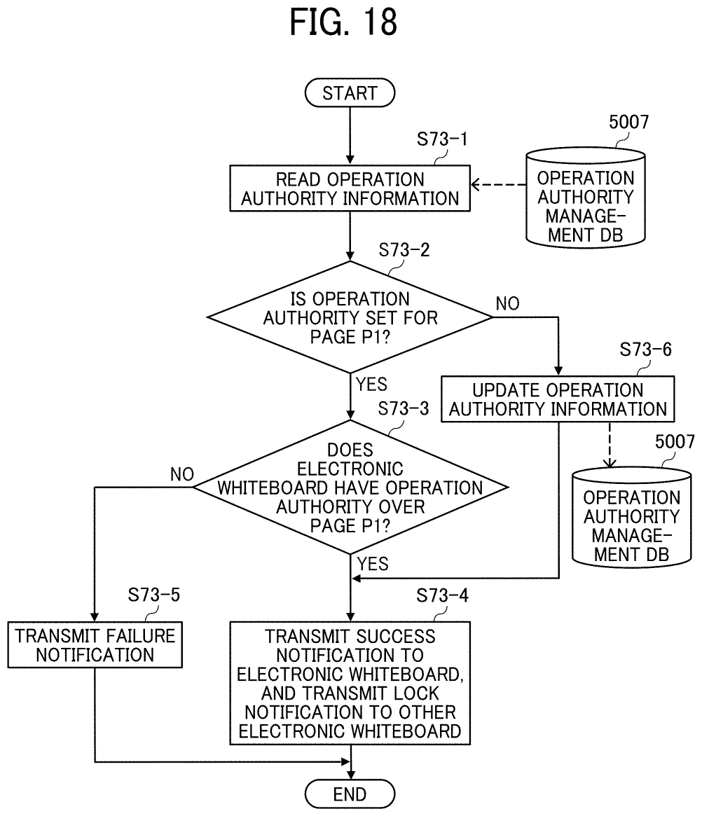

The operation authority determination process performed by the communication management apparatus 5 will be described in detail with FIG. 18.

FIG. 18 is a flowchart illustrating an example of the operation authority determination process performed by the communication management apparatus 5 of the embodiment.

The storing and reading unit 59 first reads, from the operation authority information stored in the operation authority management DB 5007 (see FIG. 11B), the operation authority information corresponding to the page P1 with the page ID “pag01,” which is the target of the object operation request (step S73-1). Then, with reference to the operation authority information read at step S73-1, the operation authority managing unit 58 determines whether the operation restriction is set for the page P1 (step S73-2). If the operation authority state in the operation authority information is “LOCKED,” the operation authority managing unit 58 determines that the operation restriction is set for the page P1. If the operation authority state in the operation authority information is “UNLOCKED,” the operation authority managing unit 58 determines that the operation restriction is not set for the page P1. If the operation authority managing unit 58 determines that the operation restriction is set for the page P1 (YES at step S73-2), the communication management apparatus 5 proceeds to the process of step S73-3. If the operation authority managing unit 58 determines that the operation restriction is not set for the page P1 (NO at step S73-2), the communication management apparatus 5 proceeds to the process of step S73-6.

Then, with reference to the operation authority information read at step S73-1, the operation authority managing unit 58 determines whether the electronic whiteboard 1 having transmitted the object operation request received by the transmitting and receiving unit 51 has the operation authority over the page P1 (step S73-3). For example, in the present example, if the operating terminal included in the operation authority information is the electronic whiteboard 1a, the operation authority managing unit 58 determines that the electronic whiteboard 1a has the operation authority over the page P1, i.e., that any other electronic whiteboard 1 does not have the operation authority over the page P1. If the operation authority managing unit 58 determines that the electronic whiteboard 1 having transmitted the object operation request has the operation authority over the page P1 (YES at step S73-3), the communication management apparatus 5 proceeds to the process of step S73-4. Then, the transmitting and receiving unit 51 transmits a success notification to the electronic whiteboard 1 having transmitted the object operation request to notify that the object operation has succeeded. The transmitting and receiving unit 51 further transmits a lock notification to the other electronic whiteboard 1 to notify that the operation on the page P1 is to be restricted (step S73-4). Thereby, the electronic whiteboard 1 having received the success notification is able to perform the operation on the rendering screen 200a displayed on the display 180. The other electronic whiteboard 1 having received the lock notification, on the other hand, is unable to perform the operation on the rendering screen 200a displayed on the display 180.

If the operation authority managing unit 58 determines at step S73-3 that the electronic whiteboard 1 having transmitted the object operation request does not have the operation authority over the page P1 (NO at step S73-3), the communication management apparatus 5 proceeds to the process of step S73-5. Then, the transmitting and receiving unit 51 transmits a failure notification to the electronic whiteboard 1 having transmitted the object operation request to notify that the object operation has failed (step S73-5).

If the operation authority managing unit 58 determines at step S73-2 that the operation restriction is not set for the page P1 (NO at step S73-2), the communication management apparatus 5 proceeds to step S73-6. Then, the operation authority managing unit 58 updates the operation authority information stored in the operation authority management DB 5007 (step S73-6). For example, if the object operation request for the page P1 is received from the electronic whiteboard 1a, the operation authority managing unit 58 changes the operation authority state and the operating terminal ID in the operation authority information for the page P1 to “LOCKED” and “01aa,” respectively. Then, the transmitting and receiving unit 51 transmits the success notification to the electronic whiteboard 1a having transmitted the object operation request to notify that the object operation has succeeded.

As described above, the communication management apparatus 5 sets the operation authority for the page on which the object operation is performed by the electronic whiteboard 1a. Further, the communication management apparatus 5 restricts the operation on the page P1 by the other electronic whiteboard 1 (e.g., the electronic whiteboard 1b), to thereby prevent the plurality of electronic whiteboards 1 from contending for the operation on the page P1.

Referring back to FIG. 16, the transmitting and receiving unit 51 transmits the success notification to the electronic whiteboard 1a having transmitted the object operation request to notify that the operation on the page P1 has succeeded (step S74). Then, the transmitting and receiving unit 11a of the electronic whiteboard 1a receives the success notification transmitted from the communication management apparatus 5. The transmitting and receiving unit 51 further transmits the lock notification to the electronic whiteboard 1b (i.e., the other electronic whiteboard 1) to notify that the operation on the page P1 is to be restricted (step S75). The lock notification is an example of an operation restriction notification for restricting the operation on the display image. Then, the transmitting and receiving unit 11b of the electronic whiteboard 1b receives the lock notification transmitted from the communication management apparatus 5.

Then, the user UB1 of the electronic whiteboard 1b moves the object OB2 on the rendering screen 200a with the electronic pen 190, for example, and the receiving unit 12b receives the user operation performed on the object OB2 (step S76). For example, the user UB1 attempts to move the object OB2 on the rendering screen 200a toward the lower-right side of the rendering screen 200a to obtain a rendering screen 200c illustrated in FIG. 17C. In the electronic whiteboard 1b, however, the operation on the page P1 is restricted based on by the lock notification received at step S75. As illustrated in FIG. 17D, therefore, the display control unit 14b controls the display 180 to display a failure notification image 205 on a rendering screen 200d to notify that the object operation has failed (step S77). The electronic whiteboard 1b thus sets the operation restriction for the corresponding page in accordance with the lock notification transmitted from the communication management apparatus 5. When a user performs the object operation during the operation restriction period, therefore, the electronic whiteboard 1b notifies the user that the object operation is being restricted.

The transmitting and receiving unit 11a of the electronic whiteboard 1a transmits a transmission completion notification to the communication management apparatus 5 to notify that the transmission of the stroke data based on the object operation received at step S71 has been completed (step S78). In this case, the display control unit 14a of the electronic whiteboard 1a controls the display 180 to display the rendering screen 200b resulting from the operation on the object OB1 (see FIG. 17B). Then, the transmitting and receiving unit 51 of the communication management apparatus 5 receives the transmission completion notification transmitted from the electronic whiteboard 1a, and transmits the received transmission completion notification to the electronic whiteboard 1b (step S79). Then, the transmitting and receiving unit 11b of the electronic whiteboard 1b receives the transmission completion notification transmitted from the communication management apparatus 5.

In response to receipt of the transmission completion notification by the transmitting and receiving unit 11b, the image processing unit 16b of the electronic whiteboard 1b generates a rendering screen to be displayed on the display 180 (step S80). In this case, based on the stroke data indicated by the transmission completion notification, the image processing unit 16b generates the rendering screen 200b similar to that displayed on the electronic whiteboard 1a. Then, the display control unit 14b controls the display 180 to display the rendering screen 200b generated by the image processing unit 16b (step S81). Thereby, the electronic whiteboard 1b displays, on the display 180, the rendering screen reflecting the object operation performed by the electronic whiteboard 1a (i.e., the movement of the object OB1).

In FIG. 19, in response to receipt of the transmission completion notification transmitted from the electronic whiteboard 1a at step S78, the operation authority managing unit 58 of the communication management apparatus 5 updates the operation authority information stored in the operation authority management DB 5007 (step S82). Specifically, the operation authority managing unit 58 changes the operation authority state in the operation authority information for the page P1 to “UNLOCKED.”

Then, the transmitting and receiving unit 51 transmits a lock cancellation notification to the electronic whiteboard 1b to notify that the operation restriction on the page P1 is to be cancellated (step S83). Herein, the lock cancellation notification is an example of the operation restriction cancellation notification for canceling the operation restriction on the display image. Then, the transmitting and receiving unit 11b of the electronic whiteboard 1b receives the lock cancellation notification transmitted from the communication management apparatus 5. The electronic whiteboard 1b then executes a process of selecting the rendering content based on the operation on the page P1 received during the operation restriction period (step S84).

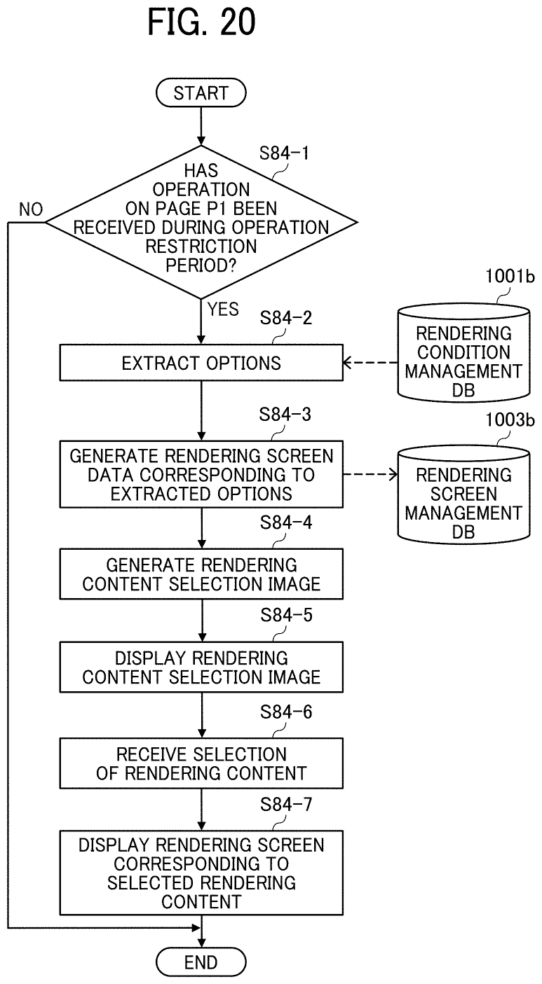

A process of selecting the rendering content in the electronic whiteboard 1b will be described in detail with FIG. 20.

FIG. 20 is a flowchart illustrating an example of a process of selecting the rendering content in the electronic whiteboard 1 of the embodiment. The determination unit 15b determines whether the operation on the page P1 has been received during the operation restriction period (step S84-1). The operation restriction period refers to the period from the receipt of the lock notification at step S75 to the receipt of the lock cancellation notification at step S83. If the determination unit 15b determines that the operation on the page P1 has been received during the operation restriction period (YES at step S84-1), the electronic whiteboard 1b proceeds to the process of step S84-2. If the determination unit 15b determines that the operation on the page P1 has not been received during the operation restriction period (NO at step S84-1), the electronic whiteboard 1b completes the present process.

The determination unit 15b performs a search through the rendering condition management DB 1001 (see FIG. 7) to extract the options corresponding to the rendering condition of the operation (step S84-2). Specifically, based on the rendering screen 200b displayed on the display 180 and the operation received during the operation restriction period (e.g., the above-described object operation for obtaining the rendering screen 200c in FIG. 17C), the determination unit 15b identifies one of the rendering conditions included in the rendering condition management table. The determination unit 15b then extracts the options corresponding to the identified rendering condition.

Then, the image processing unit 16b generates the rendering screen data for the options extracted at step S84-2 (step S84-3). Specifically, the image processing unit 16b generates the rendering screen data to be displayed on the electronic whiteboard 1b in response to selection of the options. The image processing unit 16b then stores the generated rendering screen data in a rendering screen management DB 5009.

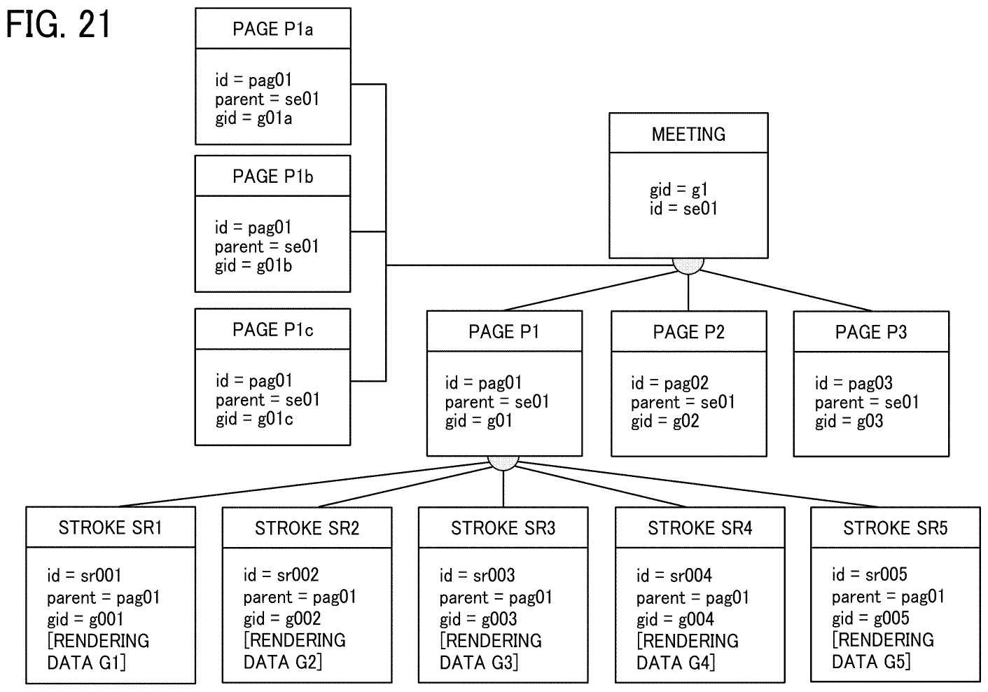

The rendering screen generated by the image processing unit 16b will be described with FIG. 21.

FIG. 21 is a diagram schematically illustrating the rendering screen information generated in the electronic whiteboard 1 of the embodiment in response to receipt of the lock cancellation notification. The rendering screen information of FIG. 21 includes, in addition to the rendering screen information of FIG. 8, information of pages P1a, P1b, and P1c each corresponding to the rendering screen generated by the image processing unit 16b.

The pages P1a, P1b, and P1c are duplicated from the page P1 to reflect the rendering contents corresponding to the options extracted at step S84-2. Each of the pages P1a, P1b, and P1c includes the same page ID as that of the page P1 (id=pag01), the information identifying the parent information “meeting” (parent=se01), and a rendering data ID different from that of the page P1 (gid=g01a, gid=g01b, or gid=g01c).

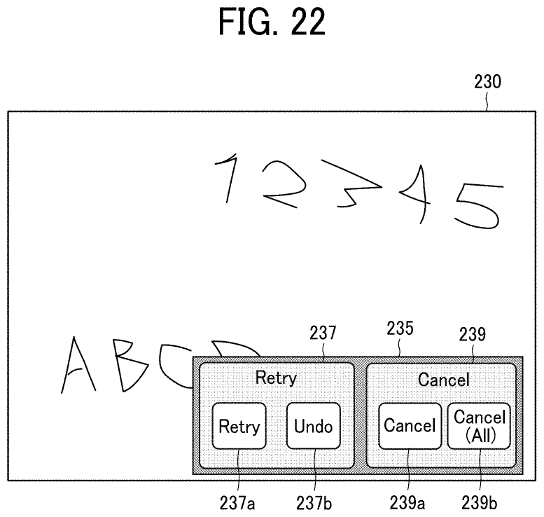

The image processing unit 16b further generates a rendering content selection image 235 (see FIG. 22) in which the options extracted at step S84-2 are displayed for selection (step S84-4). Then, the display control unit 14b controls the display 180 to display a rendering screen 230 (see FIG. 22) including the rendering content selection image 235 generated by the image processing unit 16b (step S84-5).

FIG. 22 is a diagram illustrating an example of the rendering content selection image 235 displayed on the electronic whiteboard 1 of the embodiment. The rendering content selection image 235 in FIG. 22 includes a “Retry” button 237 and a “Cancel” button 239. The “Retry” button 237 is pressed to retry the operation received during the operation restriction period. The “Cancel” button 239 is pressed to cancel the operation received during the operation restriction period.

The “Retry” button 237 includes a “Retry” button 237a and an “Undo” button 237b. The “Retry” button 237a is pressed to retry, on the rendering screen 200b displaying the operation received by the electronic whiteboard 1a, the operation received by the electronic whiteboard 1b. The “Undo” button 237b is pressed to cancel the operation received by the electronic whiteboard 1a and retry the operation received by the electronic whiteboard 1b. The “Cancel” button 239 includes a “Cancel” button 239a and a “Cancel (All)” button 239b. The “Cancel” button 239a is pressed to cancel the operation received by the electronic whiteboard 1b. The “Cancel (All)” button 239b is pressed to cancel both the operation received by the electronic whiteboard 1a and the operation received by the electronic whiteboard 1b. The rendering content selection image 235 is not limited to the above-described configuration, and may have a configuration in which the options reflecting the respective rendering contents are displayed for selection in an animation or video. Further, the rendering content selection image 235 may be displayed during the time from the receipt of the operation at step S76 to the receipt of the lock cancellation notification at step S83 in the operation restriction period.

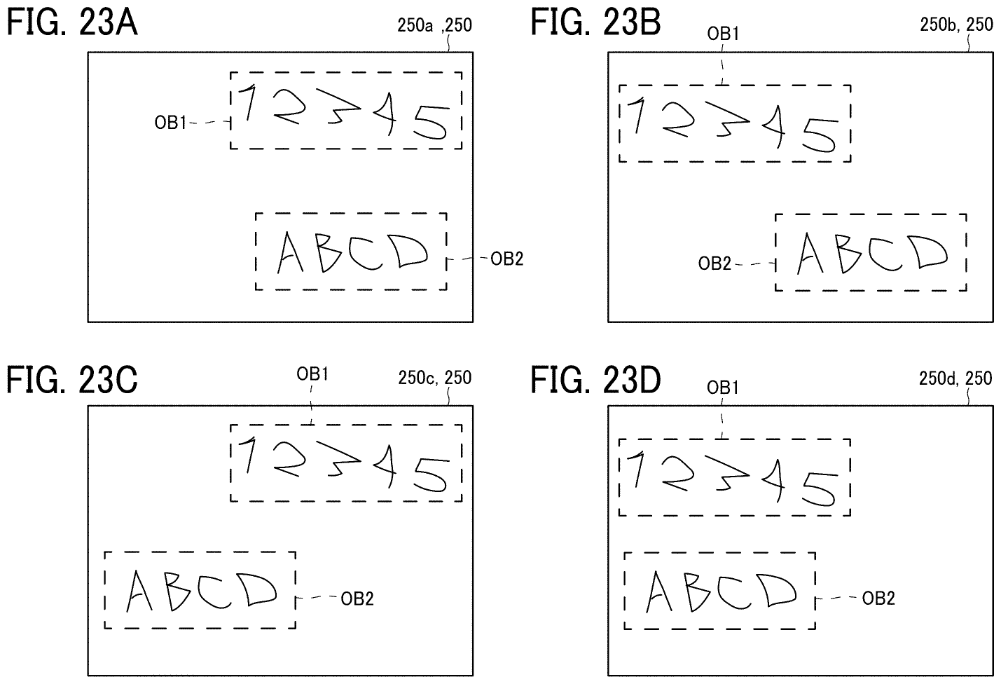

When the user UB1 presses one of the buttons displayed in the rendering content selection image 235, the receiving unit 12b receives the selection of the rendering content corresponding to the selected button (step S84-6). Then, the display control unit 14b controls the display 180 to display a rendering screen 250 based on the rendering screen data corresponding to the selected rendering content (see FIGS. 23A, 23B, 23C, and 23D) (step S84-7).

With reference to FIGS. 23A, 23B, 23C, and 23D, a description will be given of the rendering content of the rendering screen displayed based on the selection of one of the buttons displayed in the rendering content selection image 235.

FIGS. 23A, 23B, 23C, and 23D are diagrams illustrating examples of the rendering screen displayed on the electronic whiteboard 1 of the embodiment after the cancellation of the operation restriction.

FIG. 23A illustrates a rendering screen 250a, which is a display screen displayed in response to selection of the “Retry” button 237a displayed in the rendering content selection image 235. In this case, the rendering screen 250a displays the rendering content in which the object operation received by the electronic whiteboard 1b during the operation restriction period is reflected in the rendering screen 200b in FIG. 17B. Specifically, the rendering screen 250a reflects the object operation received by the electronic whiteboard 1a at step S71 and the object operation received by the electronic whiteboard 1b at step S76.

FIG. 23B illustrates a rendering screen 250b, which is a display screen displayed in response to selection of the “Undo” button 237b displayed in the rendering content selection image 235. In this case, the rendering screen 250b displays the rendering content in which the object operation received by the electronic whiteboard 1a is cancelled and the object operation received by the electronic whiteboard 1b during the operation restriction period is reflected in the rendering screen 200b in FIG. 17B. Specifically, in the rendering screen 250b, the object operation received by the electronic whiteboard 1a at step S71 is cancelled, and the object operation received by the electronic whiteboard 1b at step S76 is reflected.

FIG. 23C illustrates a rendering screen 250c, which is a display screen displayed in response to selection of the “Cancel” button 239a displayed in the rendering content selection image 235. In this case, the rendering screen 250c displays the rendering content in which the object operation received by the electronic whiteboard 1b during the operation restriction period is not reflected in the rendering screen 200b in FIG. 17B. Specifically, in the rendering screen 250c, the object operation received by the electronic whiteboard 1a at step S71 is reflected, and the object operation received by the electronic whiteboard 1b at step S76 is not reflected. That is, the rendering content of the rendering screen 250c is the same as that of the rendering screen 200b illustrated in FIG. 17B.

FIG. 23D illustrates a rendering screen 250d, which is a display screen displayed in response to selection of the “Cancel (All)” button 239b displayed in the rendering content selection image 235. In this case, the rendering screen 250d displays the rendering content in which the object operation received by the electronic whiteboard 1 a is cancelled, and the object operation received by the electronic whiteboard 1b during the operation restriction period is not reflected in the rendering screen 200b in FIG. 17B. Specifically, in the rendering screen 250d, the object operation received by the electronic whiteboard 1a at step S71 is cancelled, and the object operation received by the electronic whiteboard 1b at step S76 is not reflected. That is, the rendering content of the rendering screen 250d is the same as that of the rendering screen 200a illustrated in FIG. 17A.

In accordance with the user selection of one of the buttons in the rendering content selection image 235, the electronic whiteboard 1b thus displays the rendering screen 250 reflecting the operation received during the operation restriction period. Further, the image processing unit 16b previously generates the candidate pages (i.e., rendering screen data items) for the rendering content to be displayed after the cancellation of the operation restriction. Thereby, the electronic whiteboard 1b displays the rendering screen 250 on the display 180 in accordance with the rendering content selected by the user.

The electronic whiteboard 1b may delete, from the rendering screen data items stored in the rendering screen management DB 1003b, the rendering screen data items corresponding to the options not selected by the user. Further, if the user selection of one of the options is not received within a predetermined time (e.g., approximately five seconds) after the display of the rendering content selection image 235 on the display 180, the electronic whiteboard 1b may automatically cancel the operation received during the operation restriction period. In this case, when the predetermined time elapses after the display of the rendering content selection image 235 on the display 180, the display control unit 14b of the electronic whiteboard 1b controls the display 180 to display the rendering screen 250c illustrated in FIG. 23C.

Referring back to FIG. 19, the transmitting and receiving unit 11b of the electronic whiteboard 1b transmits an object operation request to the communication management apparatus 5 to request the object operation corresponding to the rendering content selected at step S84-6 (step S 85). Then, the transmitting and receiving unit 51 of the communication management apparatus 5 receives the object operation request transmitted from the electronic whiteboard 1b.

The rendering screen information managing unit 57 of the communication management apparatus 5 then updates the stroke data stored in the rendering screen information management DB 5006 to the stroke data corresponding to the object operation request received by the transmitting and receiving unit 51 (step S86). The transmitting and receiving unit 51 then transmits the object operation request transmitted from the electronic whiteboard 1b to the electronic whiteboard 1a (step S87). Then, the transmitting and receiving unit 11a of the electronic whiteboard 1a receives the object operation request transmitted from the communication management apparatus 5.

Based on the object operation request received by the transmitting and receiving unit 11a, the image processing unit 16a of the electronic whiteboard 1a generates the rendering screen 250 to be displayed on the display 180 (step S88). Then, the display control unit 14a controls the display 180 to display the rendering screen 250 generated by the image processing unit 16a (step S89). The communication system 10 thus enables the electronic whiteboards 1a and 1b to display the shared rendering screen 250.

As described above, in accordance with the user selection with the rendering content selection image 235, the communication system 10 of the embodiment enables the plurality of electronic whiteboards 1 to share and display the rendering screen 250 reflecting the operation received by one of the electronic whiteboards 1 during the operation restriction period thereof.

According to an existing method, the access right is managed to avoid inconsistency due to the contention for the operation on the rendering screen, such as input or editing to the rendering screen, between a plurality of electronic whiteboards sharing the rendering screen. According to such a method, however, it is difficult to recover the operation unsuccessfully performed by one of the electronic whiteboards due to the lack of the operation authority. In the present embodiment, on the other hand, even if the object operation on the rendering screen by one of the electronic whiteboards 1 fails due to the operation restriction on the rendering screen, the rendering content selection image 235 displayed after the cancellation of the operation restriction enables the object operation performed during the operation restriction period to be reflected in the rendering screen. The rendering screen described above is an example of the display image displayed on the display 180.

A communication system 10b of a modified example of the embodiment will be described. The same components and functions as those of the above-described embodiment will be denoted with the same reference numerals, and description thereof will be omitted.

According to the communication system 10b of the modified example, each time the electronic whiteboard 1 receives the object operation, a communication management apparatus 5b determines whether the operation authority is set. Further, according to the communication system 10b of the modified example, the communication management apparatus 5b generates the rendering screen data in accordance with the operation received by the electronic whiteboard 1 during the operation restriction period thereof.

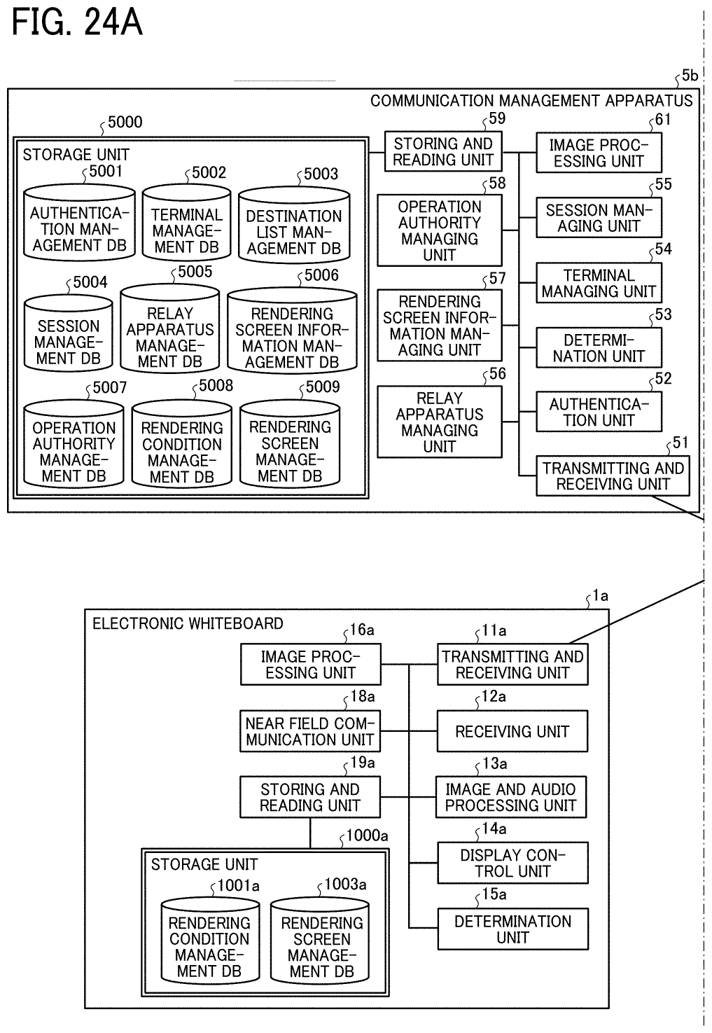

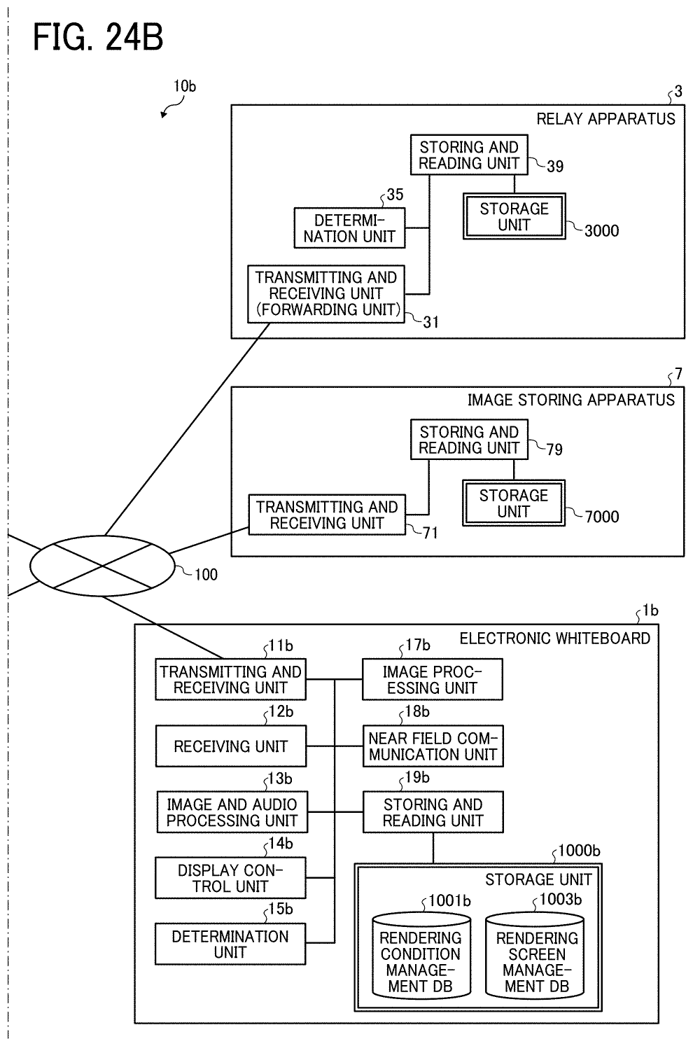

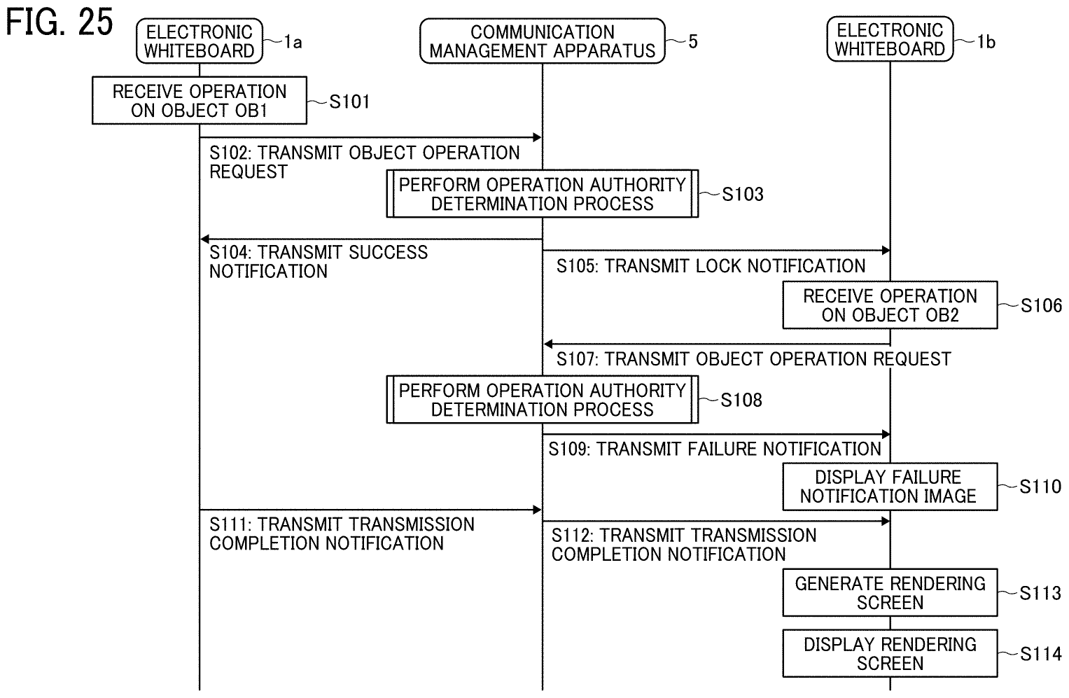

FIGS. 24A and 24B are diagrams illustrating an example of the functional configuration of the communication system 10b according to the modified example. The apparatuses and terminals of the communication system 10b other than the communication management apparatus 5b are similar in function to those of the communication system 10 illustrated in FIGS. 6A and 6B, and thus description thereof will be omitted.

The communication management apparatus 5b of the modified example includes an image processing unit 61 in addition to the functions of the communication management apparatus 5 illustrated in FIG. 6A. The image processing unit 61 is a function implemented by a command from the CPU 501 in FIG. 4 to generate the rendering screen data of the rendering screen displayed on the electronic whiteboard 1.

Further, the storage unit 5000 stores a rendering condition management DB 5008 and a rendering screen management DB 5009 in addition to the databases of the communication management apparatus 5 illustrated in FIG. 6A. The rendering condition management DB 5008 and the rendering screen management DB 5009 are similar in configuration to the rendering condition management DB 1001 and the rendering screen management DB 1003, respectively, of the electronic whiteboard 1.

Operations and processes of the communication system 10b of the modified example will be described with FIGS. 25 to 27.

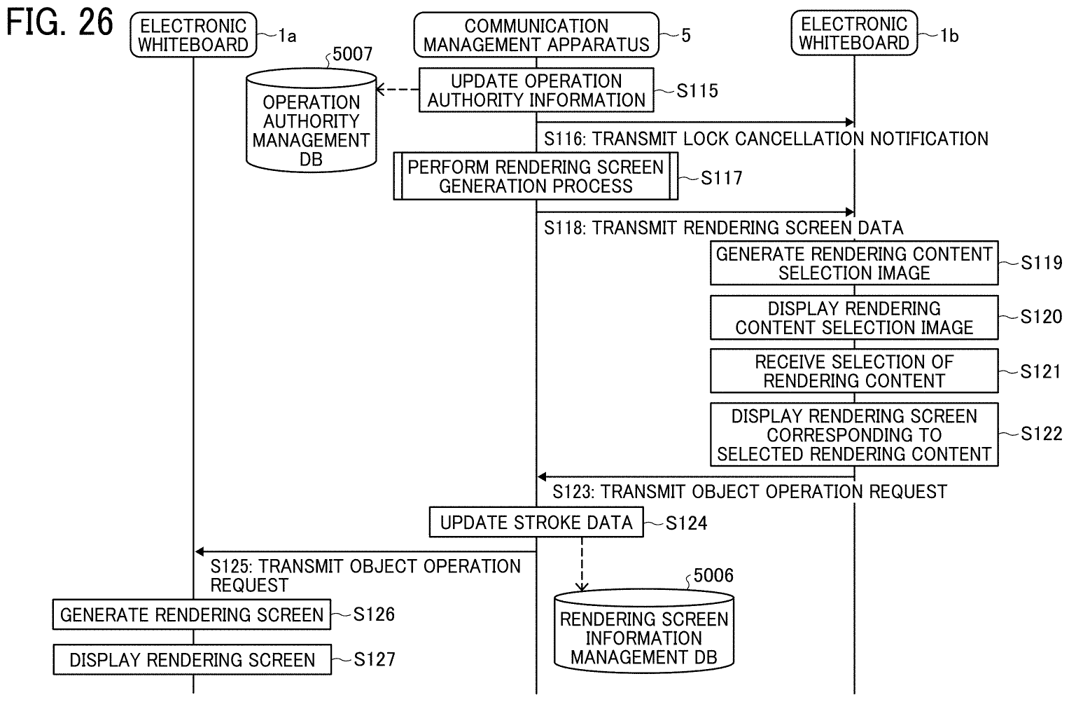

FIGS. 25 and 26 are sequence diagrams illustrating an example of a process of performing rendering on the electronic whiteboard 1 in accordance with the operation restriction in the communication system 10b of the modified example. It is assumed here that the rendering screen 200a (see FIG. 17A) is displayed on the display 180 of each of the electronic whiteboards 1a and 1b in the process of FIGS. 25 and 26 similarly as in the process of FIGS. 16 and 19.

The user UA1 of the electronic whiteboard 1a first moves the object OB1 on the rendering screen 200a (see FIG. 17A) with the electronic pen 190, for example, and the receiving unit 12a receives the user operation performed on the object OB1 (step S101). For example, the user UA1 moves the object OB1 on the rendering screen 200a toward the upper-right side of the rendering screen 200a to obtain the rendering screen 200b illustrated in FIG. 17B. Then, the transmitting and receiving unit 11a transmits to the communication management apparatus 5b the object operation request that requests the operation on an object rendered on the page P1 (step S102). Then, the transmitting and receiving unit 51 of the communication management apparatus 5b receives the object operation request transmitted from the electronic whiteboard 1a.

Then, based on the object operation request received by the transmitting and receiving unit 51, the communication management apparatus 5b executes the operation authority determination process (step S103). The operation authority determination process of step S103 is similar to that of FIG. 18, and thus description thereof will be omitted.

The transmitting and receiving unit 51 transmits the success notification to the electronic whiteboard 1a having transmitted the object operation request to notify that the object operation on the page P1 has succeeded (step S104). Then, the transmitting and receiving unit 11a of the electronic whiteboard 1a receives the success notification transmitted from the communication management apparatus 5b. The transmitting and receiving unit 51 further transmits the lock notification to the electronic whiteboard 1b (i.e., the other electronic whiteboard 1) to notify that the operation on the page P1 is to be restricted (step S105). Then, the transmitting and receiving unit 11b of the electronic whiteboard 1b receives the lock notification transmitted from the communication management apparatus 5b.

Then, the user UB1 of the electronic whiteboard 1b moves the object OB2 on the rendering screen 200a with the electronic pen 190, for example, and the receiving unit 12b receives the user operation performed on the object OB2 (step S106). For example, the user UB1 moves the object OB2 on the rendering screen 200a toward the lower-right side of the rendering screen 200a to obtain the rendering screen 200c illustrated in FIG. 17C. Then, the transmitting and receiving unit 11b transmits to the communication management apparatus 5b the object operation request that requests the operation on an object rendered on the page P1 (step S107). Then, the transmitting and receiving unit 51 of the communication management apparatus 5b receives the object operation request transmitted from the electronic whiteboard 1b.

Then, based on the object operation request received by the transmitting and receiving unit 51, the communication management apparatus 5b executes the operation authority determination process (step S108). The operation authority determination process of step S108 is similar to that of FIG. 18, and thus description thereof will be omitted. In the present example, the electronic whiteboard 1b does not have the operation authority over the page P1 (NO at step S73-3 in FIG. 18), and thus the transmitting and receiving unit 51 of the communication management apparatus 5b transmits the failure notification to the electronic whiteboard 1b having transmitted the object operation request to notify that the object operation has failed (step S109). Herein, the failure notification is an example of the operation restriction notification for restricting the operation on the display image. Then, the transmitting and receiving unit 11b of the electronic whiteboard 1b receives the failure notification transmitted from the communication management apparatus 5b. Then, the display control unit 14b of the electronic whiteboard 1b controls the display 180 to display the failure notification image 205 notifying that the object operation has failed, as illustrated in FIG. 17D (step S110). In response to receipt of the failure notification transmitted from the communication management apparatus 5b, the electronic whiteboard 1b thus displays the failure notification image 205 notifying that the object operation performed on the corresponding page has failed. If the object operation is performed by a user during the operation restriction period, therefore, the electronic whiteboard 1b notifies the user that the object operation is being restricted. The communication management apparatus 5b of the modified example may omit the process at step S105 of transmitting the lock notification to the electronic whiteboard 1b. Even if the lock notification is not transmitted to the electronic whiteboard 1b, the electronic whiteboard 1b later receives the failure notification notifying the failure of the received operation, and thus is able to notify the user that the object operation is being restricted.

The transmitting and receiving unit 11a of the electronic whiteboard 1a transmits the transmission completion notification to the communication management apparatus 5b to notify that the transmission of the stroke data based on the object operation received at step S101 has been completed (step S111). In this case, the display control unit 14a of the electronic whiteboard 1a controls the display 180 to display the rendering screen 200b resulting from the operation on the object OB1 (see FIG. 17B). Then, the transmitting and receiving unit 51 of the communication management apparatus 5b receives the transmission completion notification transmitted from the electronic whiteboard 1a, and transmits the received transmission completion notification to the electronic whiteboard 1b (step S112). Then, the transmitting and receiving unit 11b of the electronic whiteboard 1b receives the transmission completion notification transmitted from the communication management apparatus 5b.

In response to receipt of the transmission completion notification by the transmitting and receiving unit 11b, the image processing unit 16b of the electronic whiteboard 1b generates the rendering screen to be displayed on the display 180 (step S113). In this case, based on the stroke data indicated by the transmission completion notification, the image processing unit 16b generates the rendering screen 200b similar to that displayed on the electronic whiteboard 1a. Then, the display control unit 14b controls the display 180 to display the rendering screen 200b generated by the image processing unit 16b (step S114). Thereby, the electronic whiteboard 1b displays, on the display 180, the rendering screen reflecting the object operation performed by the electronic whiteboard 1a (i.e., the movement of the object OB1).

In FIG. 26, in response to receipt of the transmission completion notification transmitted from the electronic whiteboard 1a at step S111, the operation authority managing unit 58 of the communication management apparatus 5b updates the operation authority information stored in the operation authority management DB 5007 (step S115). Specifically, the operation authority managing unit 58 changes the operation authority state in the operation authority information for the page P1 to “UNLOCKED.”

Then, the transmitting and receiving unit 51 transmits the lock cancellation notification to the electronic whiteboard 1b to notify that the operation restriction on the page P1 is to be cancellated (step S116). Then, the transmitting and receiving unit 11b of the electronic whiteboard 1b receives the lock cancellation notification transmitted from the communication management apparatus 5b. The communication management apparatus 5b further executes a process of generating rendering screens as the candidates for the display screen to be displayed on the electronic whiteboard 1b (step S117).

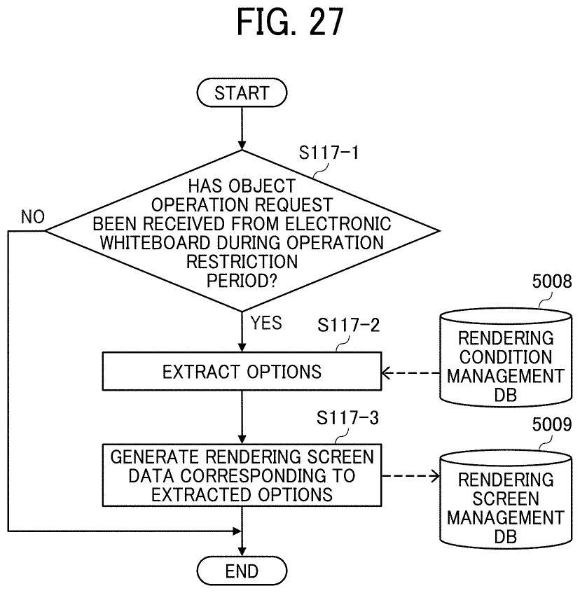

The process of generating the rendering screens executed in the communication management apparatus 5b will be described with FIG. 27.

FIG. 27 is a flowchart illustrating an example of the process of generating the rendering screens in the communication management apparatus 5b of the modified example. The determination unit 53 first determines whether the object operation request has been received from the electronic whiteboard 1b during the operation restriction period (step S117-1). If the object operation request has been received from the electronic whiteboard 1b during the operation restriction period (YES at step S117-1), the communication management apparatus 5b proceeds to the process of step S117-2. If the object operation request has not been received from the electronic whiteboard 1b during the operation restriction period (NO at step S117-1), the communication management apparatus 5b completes the present process.

The determination unit 53 then performs a search through the rendering condition management DB 5008 (see FIG. 24A) to extract the options corresponding to the rendering condition of the operation (step S117-2). Then, the image processing unit 61 generates the rendering screen data corresponding to the options selected at step S117-2 (step S117-3). The option extraction process of step S117-2 and the rendering screen data generation process of step S117-3 are similar to the option extraction process of step S84-2 and the rendering screen data generation process of step S84-3 in FIG. 20, respectively, and thus description thereof will be omitted. In accordance with the operation received by the electronic whiteboard 1b during the operation restriction period, therefore, the communication management apparatus 5b generates the rendering screen data items as the candidates for the rendering screen to be displayed on the electronic whiteboard 1b.

Referring back to FIG. 26, the transmitting and receiving unit 51 transmits the rendering screen data generated by the image processing unit 61 to the electronic whiteboard 1b (step S118). Then, the transmitting and receiving unit 11b of the electronic whiteboard 1b receives the rendering screen data transmitted from the communication management apparatus 5b. Further, the image processing unit 16b of the electronic whiteboard 1b generates the rendering content selection image 235 in which the options corresponding to the rendering screen data received by the transmitting and receiving unit 11b are displayed for selection (step S119). Then, the display control unit 14b controls the display 180 to display the rendering screen 230 (see FIG. 22) including the rendering content selection image 235 generated by the image processing unit 16b (step S120).

When the user UB1 presses one of the buttons displayed in the rendering content selection image 235, the receiving unit 12b receives the selection of the rendering content corresponding to the selected button (step S121). Then, the display control unit 14b controls the display 180 to display the rendering screen 250 based on the rendering screen data corresponding to the selected rendering content (see FIG. 23A, 23B, 23C, or 23D) (step S122). The following processes of steps 5123 to 5127 are similar to those of steps S85 to S89 in FIG. 19, and thus description thereof will be omitted.

As described above, according to the communication system 10b of the modified example, each time the objection operation is received by one of the plurality of electronic whiteboards 1, the communication management apparatus 5b transmits to the electronic whiteboard 1 the information of whether the electronic whiteboard 1 has the operation authority, thereby preventing the contention for the operation between the plurality of the electronic whiteboards 1. Further, according to the communication system 10b of the modified example, when the object operation is received by the electronic whiteboard 1 during the operation restriction period, the communication management apparatus 5b generates the rendering screen data in accordance with the received object operation and transmits the generated rendering screen data to the electronic whiteboard 1. Thereby, the electronic whiteboard 1 is provided with the screen data items as the candidates for the rendering screen to be displayed on the electronic whiteboard 1 after the cancellation of the operation restriction.

As described above, the electronic whiteboard 1b according to an embodiment of the present invention is a communication terminal that shares the rendering screen (an example of the display image) to be displayed on the display 180 (an example of the display) with another communication terminal (e.g., the electronic whiteboard 1a) via the communication network 100. The electronic whiteboard 1b (i.e., the communication terminal) receives, from the communication management apparatus 5 that manages data shared between the electronic whiteboard 1b (i.e., the communication terminal) and the another communication terminal (e.g., the electronic whiteboard 1a), the lock notification (an example of the operation restriction notification) for restricting the operation on the rendering screen. In response to receipt of the operation performed on the rendering screen during the operation restriction period in which the operation on the rendering screen is restricted, the electronic whiteboard 1b controls the display 180 to display the rendering content selection image 235 including a plurality of options as to whether to reflect the received operation in the display image. Thereby, the electronic whiteboard 1b reflects the operation received during the operation restriction period in the display image shared by a plurality of electronic whiteboards (e.g., the electronic whiteboards 1b and 1a).

Further, the electronic whiteboard 1b (an example of the communication terminal) according to the embodiment receives the selection of one of the plurality of options in the displayed rendering content selection image 235, and transmits the rendering screen data (an example of the image data) corresponding to the selected one of the plurality of options to the another communication terminal 1 (e.g., the electronic whiteboard 1a). Then, the electronic whiteboard 1b controls the display 180 (an example of the display) to display the rendering screen 250 (an example of the display image) corresponding to the selected option. Thereby, the electronic whiteboard 1b shares the rendering screen 250, which reflects the operation received during the operation restriction period, with the electronic whiteboard 1a.

Further, in response to receipt of selection of one of the plurality of options in the displayed rendering content selection image 235, the electronic whiteboard 1b (an example of the communication terminal) according to the embodiment controls the display 180 (an example of the display) to display the display image reflecting the operation received during the operation restriction period (e.g., the rendering screen 250a or 250b). In accordance with the user selection, therefore, the electronic whiteboard 1b retries the operation received during the operation restriction period.

Further, in response to receipt of selection of one of the plurality of options in the displayed rendering content selection image 235, the electronic whiteboard 1b (an example of the communication terminal) according to the embodiment controls the display 180 (an example of the display) to display the display image reflecting the cancellation of the operation received during the operation restriction period (e.g., the rendering screen 250c or 250d). In accordance with the user selection, therefore, the electronic whiteboard 1b cancels the operation received during the operation restriction period.

Further, in response to lack of receipt of selection of one of the plurality of options in the displayed rendering content selection image 235 within a certain time, the electronic whiteboard 1b (an example of the communication terminal) according to the embodiment controls the display 180 (an example of the display) to display the display image reflecting the cancellation of the operation received during the operation restriction period (e.g., the rendering screen 250c). Thereby, the electronic whiteboard 1b automatically cancels the operation received during the operation restriction period.

Further, in accordance with the operation received during the operation restriction period, the electronic whiteboard 1b (an example of the communication terminal) according to the embodiment changes the plurality of options in the rendering content selection image 235 displayed on the display 180 (an example of the display). Thereby, the electronic whiteboard 1b provides the user with different options in accordance with the operation received during the operation restriction period.

Further, in response to receipt of the operation on the display image during the operation restriction period, the electronic whiteboard 1b (an example of the communication terminal) according to the embodiment generates a plurality of rendering screen data items (examples of the image data) according to the received operation. Then, the electronic whiteboard 1b controls the display 180 (an example of the display) to display the rendering screen 250 (an example of the display image) in accordance with one of the generated plurality of rendering screen data items corresponding to the one of the plurality of options selected from the rendering content selection image 235. With the plurality of rendering screen data items thus previously generated as the candidates for the rendering content to be displayed after the cancellation of the operation restriction, the electronic whiteboard 1b controls the display 180 to display the rendering screen 250 according to the rendering content selected by the user.

Further, the communication system 10 according to an embodiment of the present invention includes a plurality of electronic whiteboards 1, which include at least the electronic whiteboard 1a (an example of a first communication terminal) and the electronic whiteboard 1b (an example of a second communication terminal), and the communication management apparatus 5. The communication management apparatus 5 receives, from the electronic whiteboard 1a (an example of the first communication terminal), the operation request to reflect the operation received by the electronic whiteboard 1a in the rendering screen (an example of the display image). In response to receipt of the operation request, the communication management apparatus 5 transmits to the electronic whiteboard 1b (an example of the second communication terminal) the lock notification for restricting the operation on the rendering screen (an example of the operation restriction notification). Then, the communication management apparatus 5 receives, from the electronic whiteboard 1a (an example of the first communication terminal), the completion notification notifying the completion of the operation received by the electronic whiteboard 1a. In response to receipt of the completion notification, the communication management apparatus 5 transmits to the electronic whiteboard 1b (an example of the second communication terminal) the lock cancellation notification for cancelling the restriction on the operation (an example of the operation restriction cancellation notification). In the communication system 10 according to the embodiment, therefore, the operation received during the operation restriction period is reflected in the display image shared by the plurality of electronic whiteboards 1.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The various tables of the embodiment described above may be generated as a result of machine learning. The mutually associated data items in each of the tables may be categorized by machine learning without the use of the tables. Herein, machine learning refers to a technology for causing a computer to acquire learning ability similar to human learning ability. According to the technology, the computer autonomously generates, from previously learned data, algorithms for making decisions such as data identification, and makes predictions by applying the algorithms to new data. The learning method for machine learning may be any of supervised learning, unsupervised learning, semi-supervised learning, reinforcement learning, and deep learning, or may be a learning method combining two or more of these learning methods. The learning method for machine learning is not limited to a particular method.

Each of the functions of the described embodiments may be implemented by one or more processing circuits or circuitry. Circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. Further, the above-described steps are not limited to the order disclosed herein.

1. A communication terminal comprising circuitry configured to
receive, from a communication management apparatus, an operation restriction notification for restricting an operation on a display image to be displayed on a display, the communication management apparatus controlling communication between the communication terminal and another communication terminal that shares data of the display image with the communication terminal, and
in response to receipt of the operation during an operation restriction period in which the operation on the display image is restricted, control the display to display a plurality of options as to whether to reflect the received operation in the display image.

2. The communication terminal of claim 1, wherein the circuitry further
receives an operation restriction cancellation notification for cancelling the restriction of the operation, and
controls the display to display the plurality of options.

3. The communication terminal of claim 1, wherein the circuitry further
receives a selection of one of the plurality of options displayed on the display,
transmits, to the another communication terminal, image data corresponding to the selected one of the plurality of options, and
controls the display to display the display image based on the selected one of the plurality of options.

4. The communication terminal of claim 3, wherein in response to receipt of the selection of the one of the plurality of options, the circuitry controls the display to display the display image, the display image reflecting the operation received during the operation restriction period.

5. The communication terminal of claim 4, wherein the display image further reflects cancellation of an operation received by the another communication terminal.

6. The communication terminal of claim 3, wherein in response to receipt of the selection of the one of the plurality of options, the circuitry controls the display to display the display image, the display image reflecting cancellation of the operation received during the operation restriction period.

7. The communication terminal of claim 6, wherein the display image further reflects cancellation of an operation received by the another communication terminal.

8. The communication terminal of claim 3, wherein in response to lack of receipt of the selection of the one of the plurality of options within a certain time, the circuitry controls the display to display the display image, the display image reflecting cancellation of the operation received during the operation restriction period.

9. The communication terminal of claim 1, wherein in accordance with the operation received during the operation restriction period, the circuitry changes the plurality of options displayed on the display.

10. The communication terminal of claim 3, wherein in response to receipt of the operation during the operation restriction period, the circuitry further generates a plurality of image data items in accordance with the received operation, and
controls the display to display the display image in accordance with one of the plurality of image data items corresponding to the selected one of the plurality of options.

11. A communication system comprising:
a plurality of communication terminals including at least a first communication terminal and a second communication terminal each configured as the communication terminal of claim 1; and
a communication management apparatus including circuitry configured to
receive, from the first communication terminal, an operation request to reflect an operation received by the first communication terminal in a display image to be displayed on a display, and
in response to receipt of the operation request from the first communication terminal, transmit to the second communication terminal an operation restriction notification for restricting an operation on the display image.

12. The communication system of claim 11, wherein the circuitry of the communication management apparatus further
receives, from the first communication terminal, a completion notification notifying completion of the operation received by the first communication terminal, and
in response to receipt of the completion notification from the first communication terminal, transmits to the second communication terminal an operation restriction cancellation notification for cancelling the restriction of the operation.

13. An image sharing method executed by a communication terminal, the image sharing method comprising:
receiving, from a communication management apparatus, an operation restriction notification for restricting an operation on a display image to be displayed on a display, the communication management apparatus controlling communication between the communication terminal and another communication terminal that shares data of the display image with the communication terminal, and
in response to receipt of the operation during an operation restriction period in which the operation on the display image is restricted, controlling the display to display a plurality of options as to whether to reflect the received operation in the display image.

14. A non-transitory recording medium storing a plurality of instructions which, when executed by one or more processors, cause the processors to perform an image sharing method comprising:
receiving, from a communication management apparatus, an operation restriction notification for restricting an operation on a display image to be displayed on a display, the communication management apparatus controlling communication between the communication terminal and another communication terminal that shares data of the display image with the communication terminal, and
in response to receipt of the operation during an operation restriction period in which the operation on the display image is restricted, controlling the display to display a plurality of options as to whether to reflect the received operation in the display image.
